(19) United States
(12) Patent Application Publication
(10) Pub. No.: US 2017/0161203 A1
(43) Pub. Date: Jun. 8, 2017

(54) INCREASED MEMORY CAPACITY

(71) Applicant: Intel Corporation, Santa Clara, CA (US)

(72) Inventors: ALAA R. ALAMELDEEN, Hillsboro, OR (US); SANJEEV N. TRIKA, Portland, OR (US)

(73) Assignee: Intel Corporation, Santa Clara, CA (US)

(21) Appl. No.: 14/958,364

(22) Filed: Dec. 3, 2015

(51) Int. Cl. G06F 12/10; G06F 12/02

(52) U.S. Cl. CPC G06F 12/1009; G06F 12/0238; G06F 2212/202; G06F 2212/1044

(57) ABSTRACT

One embodiment provides an apparatus. The apparatus includes a translation module to map an operating system (OS) visible memory page (OS page) to at least a portion of an actual physical memory page (mem page) or to an alternative storage device. The OS page is interpreted by an OS as a physical memory page. An OS visible memory capacity is greater than an actual physical memory capacity.

### FIELD

The present disclosure relates to memory capacity, in particular to, increased memory capacity.

### BACKGROUND

In most computing systems, physical memory capacity is limited. In operation, the physical memory may be shared by a plurality of applications and the sharing may be managed by an operating system (OS). If the memory capacity requested by the applications exceeds the available memory capacity, the OS may swap pages (i.e., blocks of memory) of information, including instructions and/or data, out to nonvolatile storage, e.g., a hard disk drive (HDD). Such swapping results in a performance penalty compared to memory accesses since HDD access time is much greater than memory access time.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of an increased memory capacity system consistent with several embodiments of the present disclosure;

FIGS. 2A through 2E are illustrative examples illustrating one operating system (OS) visible memory page (OS page) stored to one actual physical memory page (mem page);

FIGS. 3A through 3D are illustrative examples illustrating one zero OS page and one other OS page mapped and/or stored to one mem page;

FIGS. 4A and 4B are illustrative examples illustrating two OS pages stored to one mem page and further illustrating one field indicating OS page state or OS page state and mem page portion identifier (ID);

FIG. 5 is a flowchart of boot operations according to various embodiments of the present disclosure;

FIG. 6 is a flowchart of increased memory capacity operations according to various embodiments of the present disclosure;

FIG. 7 is a flowchart of write operations according to various embodiments of the present disclosure; and

FIG. 8 is a flowchart of read operations according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to increased memory capacity. An apparatus, method and/or system are configured to map an operating system (OS) visible memory page (OS page) to at least a portion of an actual physical memory page (mem page) or to an alternative storage device. Mapping includes relating an OS page number to a mem page number. A page can correspond to a block of memory. A number of bytes in a block is then a “page size”. Each OS page is configured to be interpreted by the OS as a physical memory page. The OS is unaware of the mapping of the OS page to at least a portion of a mem page or to the alternative storage device. In other words, the mapping is transparent to the OS. The apparatus, method and/or system may compress one or more OS page(s) and/or combine a zero OS page with an uncompressed OS page, thus, allowing a plurality of OS pages to be mapped and stored to a single mem page. An OS visible memory capacity is greater than an actual physical memory (“main memory”) capacity, thus providing increased memory capacity without increasing actual memory size.

The apparatus, method and/or system may utilize a translation data structure. The translation data structure is configured to store translation data, e.g., mapping data and translation metadata. The mapping data includes forward mapping data and may include inverse mapping data. The forward mapping data is configured to relate or map, each OS page to a respective mem page or to the alternative storage device that stores the OS page. The inverse mapping data is configured to indicate whether a selected mem page contains an OS page and, if so, to identify each OS page of one or more OS page(s) that may be contained in the selected mem page. In other words, for each mem page that stores at least one OS page, the inverse mapping data is configured to identify each OS page of the at least one OS page. The translation metadata is configured to indicate a state of each corresponding OS page, i.e., whether the corresponding OS page contains all zeros, is compressed or is uncompressed. If the corresponding OS page is compressed or is zero and is stored to a respective mem page portion, the translation metadata is configured to identify a respective mem page portion that contains the OS page. One mem page may thus contain one OS page of any state, a plurality of compressed OS pages or a plurality of OS pages with at least one OS page a zero OS page, as described herein. An OS page that contains all zeros and an uncompressed OS page may both be mapped to a same mem page. Compressing OS page(s) and mapping a plurality of OS pages to one mem page are configured to increase an OS visible memory capacity without increasing actual memory size.

The apparatus, method and/or system are configured to determine, based, at least in part, on the translation data structure, a current state of a target OS page, a current storage location of the target OS page, a next state of the target OS page and/or a next storage location of the target OS page. Operations associated with the apparatus, method and/or system may be initiated in response to a memory access attempt by the OS and/or the processor. In other words, if the OS page or portion of OS page to be accessed resides in a processor cache memory, the operations associated with the apparatus, system and/or method may not be performed since main memory is not being accessed.

In some situations, an OS page to be written may not fit in the actual physical memory. In other words, no mem page with adequate space may be available. In these situations, one or more “victim” OS page(s) may be selected and stored to an alternative storage device. For example, one or more victim OS page(s) may be temporarily stored to a cache, e.g., a victim cache. In another example, the victim OS page(s) may be stored to nonvolatile storage. Nonvolatile storage may include, but is not limited to, a solid state drive (SSD), a hard disk drive (HDD), removable nonvolatile (NV) storage, etc. For example, for an alternative storage device that is an SSD, the SSD may include a translation storage portion that is not visible to the OS and a general storage portion. The victim OS pages may be stored to the translation storage portion. A size of the translation storage portion is related to a size of OS visible memory and a size of actual physical memory. For example, the size of the translation storage portion may be selected so that the size of the translation storage portion corresponds to a difference between the size of the OS visible memory and the size of the actual physical memory. The SSD, e.g., an SSD controller, may be configured to provide the OS access to the general storage portion and not to the translation storage portion.

Thus, a physical memory that has a physical memory capacity appears to the OS as having an OS visible memory capacity greater than the actual physical memory capacity. The OS may then utilize the increased memory capacity without awareness of the translation between the OS visible memory and the actual physical memory or alternative storage device.

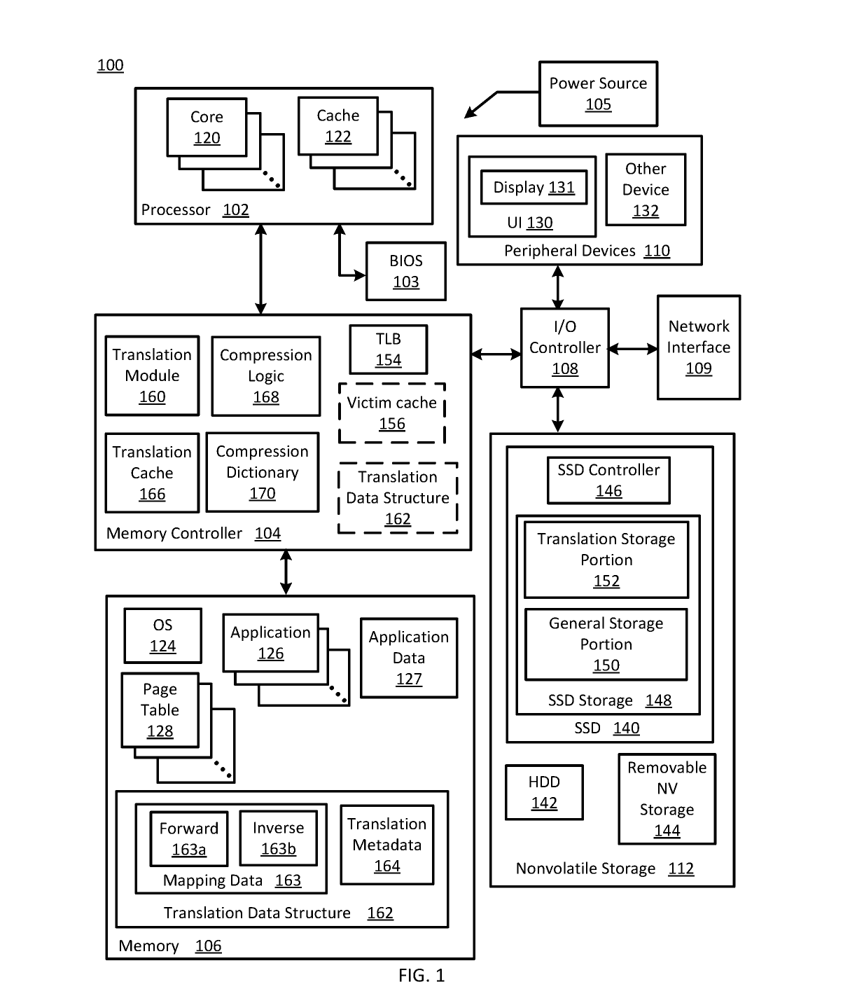

FIG. 1 illustrates a functional block diagram of an increased memory capacity system 100 consistent with several embodiments of the present disclosure. The system 100 may include, but is not limited to, a mobile telephone including, but not limited to, a smart phone (e.g., iPhone®, Android®-based phone, Blackberry®, Symbian®-based phone, Palm®-based phone, etc.); a wearable device (e.g., wearable computer, “smart” watches, smart glasses, smart clothing, etc.) and/or system; an Internet of Things (IoT) networked device including, but not limited to, a sensor system (e.g., environmental, position, motion, etc.) and/or a sensor network (wired and/or wireless); a computing system (e.g., a server, a workstation computer, a desktop computer, a laptop computer, a tablet computer (e.g., iPad®, GalaxyTab® and the like), an ultraportable computer, an ultramobile computer, a netbook computer and/or a subnotebook computer; etc.

The system 100 includes a processor 102, a basic input/output system (BIOS) 103, a memory controller 104, a power source 105, a memory 106, an input/output (I/O) controller 108, a network controller 109, peripheral devices 110 and nonvolatile storage 112. The power source 105 is configured to provide power to one or more element(s) of system 100. For example, power source 105 may include, but is not limited to, a power supply configured to convert alternating current (AC) input to direct current (DC) output, a battery, a solar cell, etc. Network controller 109 is configured to couple system 100 to one or more other system(s) (not shown), wired and/or wirelessly, via a network (not shown) and/or directly.

The processor 102 may include one or more core(s), e.g., core 120, and one or more caches, e.g., cache 122. The caches may be multilevel. Processor 102 is configured to perform operations of system 100. BIOS 103 is configured to perform hardware initialization during a booting process (e.g., power-on startup) and may be configured to provide runtime services for an OS. Memory 106 may include an operating system OS 124, one or more application(s), e.g., application 126, application data 127 and one or more page table(s), e.g., page table 128. Each application may have a corresponding page table, e.g., application 126 and page table 128. OS 124 is configured to manage mapping virtual memory associated with, e.g., application 126 and/or application data 127 to OS visible memory via page table 128, thus facilitating sharing memory 106 by a plurality of applications, e.g., application 126.

I/O controller 108 is configured to couple memory controller 104, and thereby processor 102, to peripheral devices 110 and/or nonvolatile storage 112. I/O controller 108 may be further configured to couple network interface 109 to other element(s) of system 100, e.g., processor 102. Peripheral devices 110 may include a user interface (UI) 130 and/or other device(s) 132. UI 130 may include a key pad, keyboard, touch pad, mouse, display 131 (including a touch sensitive display) configured to receive user input and/or to output, i.e., display, information to a user. The other device(s) 132 may include one or more sensor(s) including accelerometer, global positioning system (GPS), gyroscope, etc. Thus, at least one of the network interface 109, the display 131 and/or the power source 105 may be communicatively coupled to the processor 102.

Nonvolatile storage 112 may include a solid-state drive (SSD) 140, a hard disk drive (HDD) 142 and/or removable nonvolatile (NV) storage 144. For example, removable NV storage 144 may include a flash drive, a compact disk drive, etc. Latency, i.e., access time, associated with accessing an SSD is generally less than the latency associated with accessing an HDD. Latency associated with accessing the SSD by a memory controller, e.g., memory controller 104, is less than latency associated with accessing the SSD by an OS, e.g., OS 124. For example, SSD 140 may include three-dimensional cross point storage technology.

In some embodiments, any part of nonvolatile storage 112 may include emerging non volatile byte addressable random access memory technology such as, to name a few possibilities, a three dimensional crosspoint memory device, a phase change based memory, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc.

The SSD 140 may include an SSD controller 146 and SSD storage 148. The SSD storage 148 may include a general storage portion 150 and a translation storage portion 152. General storage portion 150 corresponds to a portion of SSD storage 148 available for use by OS 124 and/or application 126. Translation storage portion 152 corresponds to a portion of SSD storage 148 that is not visible to OS 124. Translation storage portion 152 may be available for increased memory capacity operations, as described herein. SSD controller 146 may be configured to make only the general storage portion 150, and not translation storage portion 152, visible, and thus available, to OS 124 and/or application 126.

BIOS 103 may be configured to initiate operations of system 100 in response to a reset and/or a system power up, prior to execution of OS 124. For example, the BIOS 103 may be configured to initialize and test the system 100 hardware components and to load a boot loader and/or OS 124 from nonvolatile storage 112. BIOS 103 may include one or more registers (e.g., control registers) configured to store one or more value(s) related to operation of system 100. For example, a control register may be configured to store a page size value. A page size may be in the range of 512 bytes to 8192 bytes or may be greater than 8192 bytes. For example, the page size may correspond to 4 kilobytes (kB) (i.e., 4096 bytes).

In another example, BIOS 103 may be configured to store an OS visible memory capacity value. The OS visible memory capacity value corresponds to the OS visible memory capacity. The OS visible memory capacity corresponds to a product of a number of OS pages multiplied by the page size. The OS visible memory capacity value is interpreted by the OS 124 as the capacity of the physical memory, e.g., memory 106. In actuality, the actual capacity of the physical memory 106 is less than the OS visible memory capacity. The actual physical memory capacity corresponds to a product of a number of mem pages multiplied by the page size. The OS visible memory capacity may be related to the actual physical memory capacity by a capacity factor. For example, the OS visible memory capacity may equal the actual physical memory capacity multiplied by the capacity factor. Similarly, the number of OS pages may equal the capacity factor multiplied by the number of mem pages for a same OS page size and mem page size. The OS page size and mem page size may or may not be the same. The capacity factor is greater than one. For example, the capacity factor may be 1.5. Continuing with this example, a physical memory capacity of 4 gigabytes (GB) and a capacity factor of 1.5 yield an OS visible memory capacity of 6 GB. In another example, the capacity factor may be 2.0. Other capacity factor values can be used.

Thus, the BIOS 103 may be configured to provide an OS memory capacity to the OS 124 that is greater than the actual physical memory capacity. The OS 124 may then utilize the OS memory capacity as if it were actual physical memory without being aware that the actual physical memory capacity is less than the OS visible memory capacity. For example, the OS 124 may be configured to perform memory access operations on one or more OS pages. The OS 124 may be further configured to maintain a page table, e.g., page table 128. Page table 128 can relate one or more virtual memory page number(s) used by an application, to one or more OS page number(s). A mapping between a selected OS page and a corresponding mem page (or an alternative storage device) may be performed in response to a memory access by OS 124 and/or processor 102 and such mapping may be transparent, i.e., may not be visible, to the OS 124, as described herein. Thus, the OS 124 may utilize an increased memory capacity (i.e., OS visible memory) that is greater than the actual physical memory capacity.

Memory controller 104 is configured to manage memory accesses for system 100. Memory controller 104 may be utilized by OS 124 to access memory 106 and/or nonvolatile storage 112. Memory controller 104 includes a translation lookaside buffer (TLB) 154. As is known, the TLB 154 may be configured to cache a portion of page table 128. The page tables, e.g., page table 128, and/or TLB 154 may then be utilized by OS 124 to manage sharing memory 106 by a plurality of applications, e.g., application 126, and associated application data, e.g., application data 127.

Memory controller 104 includes a translation module 160, a translation cache 166 and compression logic 168. Memory controller may include a compression dictionary 170. In some embodiments, memory 106 may include a translation data structure 162 that includes mapping data 163 and translation metadata 164. In some embodiments, memory controller 104 may include the translation data structure 162. Mapping data 163 includes forward mapping data 163a and may include inverse mapping data 163b, as described herein.

Translation module 160 is configured to map an OS page to at least a portion of an actual physical memory page (mem page) or to an alternative storage device, e.g., SSD 140. Translation cache 166 may be configured to store at least a portion of the entries included in translation data structure 162. In other words, translation cache 166 may be configured to shorten an access time associated with accessing translation data (i.e., mapping data 163 and translation metadata 164), similar to a relation between TLB 154 and page table 128.

SSD controller 146 may be configured to provide access to translation storage portion 152 to translation module 160. Translation module 160 may then be configured to store one or more OS page(s) to translation storage portion 152. For example, translation module 160 may be configured to store one or more OS pages to translation storage portion 152 if no mem page included in memory 106 is available for storing a target OS page. Latency associated with accessing the SSD by a memory controller, e.g., memory controller 104, is less than latency associated with accessing the SSD by an OS, e.g., OS 124. Thus, latency associated with storing OS page(s) to translation storage portion 152 may be relatively small. A size of translation storage portion 152 may be related to the capacity factor. For example, the size of the translation storage portion 152 may correspond to a difference between the actual physical memory capacity and the OS visible memory capacity.

In some embodiments, memory controller 104 may include a victim cache 156. Translation module 160 may be configured to store one or more victim OS pages to victim cache 156 if no mem page has at least a portion available for storing a target OS page. For example, the victim OS page(s) may be stored in the victim cache 156 temporarily. The victim OS page(s) may then be recovered from the victim cache 156 if they are accessed by OS 124 before being evicted by OS 124 and stored to nonvolatile storage 112.

Translation data structure 162 is configured to store mapping data 163 that relates an OS page number to a mem page number and/or that relates a mem page number to one or more OS page numbers. Translation data structure 162 is further configured to store translation metadata 164 associated with each OS page number that includes OS page state information and may further include storage location information, i.e., a mem page portion identifier. For example, the translation data structure 162 may be configured as a lookup table (LUT). The translation data structure 162 may be single level or multilevel. A single level table corresponds to a LUT. A multilevel table is similar to a page table utilized by OS 124 to manage mapping virtual page numbers used by an application to an OS visible page number. In another example, the translation data structure 162 may utilize a portion of a page table, e.g., page table 128. In another example, at least a portion of the translation data structure 162 may be added to data stored in TLB 154.

Mapping data 163 includes forward mapping data 163a and may include inverse mapping data 163b. Forward mapping data 163a is configured to relate an OS page (i.e., OS page number) to a mem page (i.e., mem page number). Inverse mapping data 163b is configured to relate a mem page (i.e., mem page number) to one or more OS page(s) (i.e., OS page number(s)). Thus, as used herein “forward” corresponds to OS page to mem page mapping (i.e., OS page number as index) and “inverse” corresponds to mem page to OS page(s) mapping (i.e., mem page number as index). Translation data structure 162 thus includes a forward portion and may include an inverse portion. The forward portion includes forward mapping data 163a and translation metadata 164. The inverse portion includes the inverse mapping data 163b and the translation metadata 164. The forward portion of translation data structure 162 may be utilized by translation module 160 to, inter alia, determine a current storage location of a selected OS page. The inverse portion of the translation data structure 162 may be utilized to identify a next storage location for a selected OS page. In other words, the forward portion is indexed by OS page number and the inverse portion is indexed by mem page number.

The translation metadata 164 may include OS page state information and/or a mem page portion identifier. The OS page state information and/or the mem page portion identifier may correspond to a respective sequence of binary digits (i.e., bits). A state of an OS page may be zero, compressed or uncompressed. The translation metadata 164 may thus include a zero page indicator, a compressed indicator, an uncompressed indicator and/or a mem page portion identifier. The zero page indicator is configured to indicate that a corresponding OS page contains only zeros. The uncompressed indicator is configured to indicate that a corresponding OS page is uncompressed. The compressed indicator is configured to indicate that a corresponding OS page is compressed. The mem page portion identifier is configured to identify the portion of a mem page that contains a corresponding OS page. The corresponding OS page may be zero or compressed. Thus, a combination of mapping data (i.e., mem page number) and the mem page portion identifier may uniquely specify a location of a zero OS page or a compressed OS page in actual physical memory. In some embodiments, the compressed indicator and the mem page portion identifier may correspond to a same bit sequence. The translation metadata 164 may be utilized by, for example, translation module 160 to determine a state of a selected OS page and/or the location of a zero or compressed OS page in an associated mem page.

Thus, one or more OS page(s) may be mapped to and/or stored to one mem page. For example, a plurality of compressed OS pages may be stored to a selected mem page. Respective state information associated with each compressed OS page may then correspond to compressed. Translation metadata associated with each compressed OS page may further include a respective mem page portion identifier. A respective forward translation data structure entry associated with each compressed OS page may then include the mem page number, compression indicator and respective mem page portion identifier indexed by the OS page number of the compressed OS page. Continuing with this example, an inverse translation data structure entry associated with the mem page may then include a respective OS page number and associated translation metadata for each compressed OS page.

In another example, a zero OS page may be mapped to a mem page that contains an uncompressed OS page. Translation metadata associated with the zero OS page may then include a zero OS page indicator and the mapping data may include the mem page number. Translation metadata associated with the uncompressed OS page may then include an uncompressed OS page indicator and the mapping data may include the mem page number. A forward translation data structure entry associated with the zero OS page may then include the mem page number and zero page state indicator. A forward data structure entry associated with the uncompressed OS page may then include the mem page number and the uncompressed state indicator. Continuing with this example, an inverse translation data structure entry associated with the mem page may then include a respective OS page number and associated translation metadata for the zero OS page and uncompressed OS page.

The forward translation data structure entry may then be utilized by translation module 160 to determine a storage location (e.g., mem page number and mem page portion indicator) and a state (e.g., compressed) of a target OS page. The target OS page number corresponds to an index into the forward translation data structure portion. The inverse translation data structure entry may be utilized by translation module 160 to determine (i.e., identify) a next storage location for a target OS page. In other words, whether the mem page has available space may be determined based, at least in part, on the inverse translation data structure entry. Thus, a plurality of OS pages may be mapped to and/or stored to one mem page, providing increased memory capacity.

Compression logic 168 may be configured to compress a selected OS page or portion of the selected OS page prior to storing (i.e., writing) the selected OS page or selected OS page portion to a target portion of a target mem page. Compression logic 168 may be further configured to decompress a selected compressed OS page or compressed OS page portion as part of a read operation (i.e., a load operation). Compressing the selected OS page or OS page portion is configured to facilitate storing a plurality of OS pages to a target mem page and to thus increase a storage capacity of memory 106.

Initially, compression logic 168 may be configured to compress an entire OS page. For example, the OS page may be compressed when first loaded into memory 106, e.g., during boot operations and/or an initial load of an application. During operation, less than the entire OS page (i.e., a portion) may generally be updated in each write operation. The portion of the OS page may be related to characteristics of cache 122. The portion may correspond to a size of a cache line or to a multiple of the size of the cache line. For example, the cache line size may be in the range of 32 bytes to 1024 bytes. For example, the cache line size may be 64 bytes.

Compression logic 168 may be configured to implement a selected compression technique. Whether compression logic 168 compresses (or decompresses) an OS page or portion of the OS page may be related to the selected compression technique.

Whether an OS page or page portion may be compressed and a resulting compression ratio are related to characteristics of the contents of the OS page or page portion. For example, OS page content that includes, but is not limited to, one or more of zeros, relatively small numbers, patterns that are repeated, redundant data, runs of the same values, etc., may generally be compressible. A resulting compression ratio may be relatively larger for OS pages that include a relatively greater amount of compressible content. Such OS pages may then occupy a relatively smaller portion of a mem page.

Compression techniques have associated characteristics that may affect, e.g., compression ratio. Compression technique characteristics include compression latency, decompression latency, compressibility (i.e., related to compression ratio), capacity, power consumed during compression, power consumed during decompression, compression and decompression logic circuitry area, compression and decompression circuitry idle power, compression and decompression block data size (i.e., how many bytes to compress or decompress), dictionary size, data item granularity to detect redundancy or compressibility (e.g., examining one byte or one 32-byte word at a time), and data granularity for compressed data items (i.e., whether a data item can be compressed to 2 bits, 4-bits, one byte, . . . etc.). Compression techniques may include, but are not limited to, frequent pattern compression (FPC), base-delta-immediate compression (BDI), cache packer (CPACK) compression, run length encoding (RLE), Huffman encoding, Limpel-Ziv (LZ) compression, and deflate compression. One or more compression techniques may be configured to utilize compression dictionary 170. For example, dictionary 170 may be configured to store repeated data values. Subsequent occurrences may then refer to a dictionary entry. In another example, dictionary 170 may be configured to store a code for each data item (e.g., byte) such that the codes for relatively more frequent data items are shorter than codes for relatively less frequent (i.e., rare) data items.

The selected compression technique may be related to a target compression ratio. The target compression ratio is related to a maximum number of compressed OS pages that may be stored to one mem page. For example, a target compression ratio of 2 to 1 corresponds to a maximum of two compressed OS pages stored to one mem page. Continuing with this example, the mem page may then include two portions, with each portion configured to store a respective compressed OS page. In another example, the target compression ratio may be greater than 2 to 1 and a mem page may then be configured to store more than two compressed OS pages. In other words, in this second example, the mem page may be configured to include more than two portions.

Whether or not a selected OS page is compressible may not be known a priori. Thus, at least one of the translation module 160 and/or compression logic 168 may be configured to determine whether a selected OS page is compressible. Whether a selected OS page is compressible is related to the target compression ratio and to characteristics of contents of the OS page. For example, whether a selected OS page is compressible may be determined based, at least in part, on whether a compressed selected OS page will fit in a defined portion of the target mem page. If the compressed selected OS page will not fit in the defined portion of the target mem page, then the selected OS page may be deemed uncompressible. The selected OS page may then not be compressed and may be stored to the target mem page uncompressed. The associated translation metadata may then be configured to indicate a state of the selected OS page as uncompressed. For example, compression logic 168 may be configured to examine the selected OS page to determine a corresponding compressed size of the selected OS page. If the compressed size is less than or equal to a size of a portion of the target mem page, then the OS page may be identified as compressible. If the compressed size is larger than the size of the defined portion of the target mem page, then the OS page may be identified as uncompressed.

Translation module 160 may be configured to perform mapping operations in response to a memory access and/or memory access request by OS 124 and/or processor 102. For example, processor 102 may store recently-accessed data to a cache, e.g., cache 122. Subsequent accesses to information stored in the cache 122 that do not result in an actual access to memory 106 may not trigger operations of translation module 160. Thus, operations of translation module 160 may generally occur for only a portion of application memory access requests.

Memory access operations may be performed in response to and/or as part of system 100 boot operations, a write operation, a read operation and/or a page fault. As is known, a page fault corresponds to access to a memory page when the memory page is not included in a cache. As used herein, an OS memory access operation includes a read operation and/or a write operation that accesses memory 106. Thus, OS memory access operations may be performed in response to a system boot, a write request, a read request and/or a page fault. Translation module 160 is configured to perform mapping operations related to OS memory access operations, as described herein.

System boot operations may generally include loading the OS 124 into memory 106 from nonvolatile storage 112, e.g., HDD 142 or SSD 140. System boot operations may further include loading one or more applications, e.g., application 126, from nonvolatile storage 112, into memory 106. In some embodiments, translation data structure 162 may be allocated in memory 106 by, e.g., translation module 160, as part of system 100 boot operations. In some embodiments, translation data structure 162 may be included in memory controller 104.

Translation module 160 is further configured to initialize the translation data structure 162 as part of the boot operations. Initializing the translation data structure 162 may include determining an initial state of each OS page, determining an initial storage location of each OS page, storing each nonzero OS page to a respective initial storage location and updating mapping data 163 and translation metadata 164. Determining the initial state of each OS page may include determining whether a respective OS page is compressible and may further include compressing each compressible OS page.

The translation data structure 162 includes mapping data 163 and translation metadata 164, as described herein. Contents of the translation data structure 162 are related to the target compression ratio, as described herein.

For example, for a target compression ratio of 2 to 1, the associated translation metadata may include two bits (i.e., two binary digits) configured to indicate state. The associated translation metadata may further include two bits corresponding to a mem page portion identifier. Herein, binary digits are indicated by a prefix “0b” followed by the digits, e.g., 0bxy, where x and y correspond to binary digits. Continuing with this example, a state of an OS page that contains all zeros may be indicated by translation metadata value 0b00 and a state of an OS page that is uncompressed may be indicated by translation metadata value 0b11. The translation metadata associated with an OS page that is compressed may have the value 0b01 or 0b10. The translation metadata values associated with compressed OS pages are configured to indicate that the respective OS page is compressed and to identify a mem page storage location for each compressed OS page. For example, the value 0b01 may correspond to a top half (i.e., low order addresses) and the value 0b10 may correspond to a bottom half (i.e., high order addresses) of the mem page. A zero OS page may be mapped to a mem page or mem page portion and/or may be stored to a mem page or mem page portion. For example, mem page portion identifiers associated with a zero OS page may have the value 0b00 for a zero OS page that is mapped but not stored, 0b01 or 0b10 configured to identify mem page portion for a zero OS page stored to a respective mem page portion or 0b11 for a zero OS page stored to an entire mem page.

In another example, a mem page may be configured to store more than two compressed OS pages. The translation metadata may then include more than two, e.g., three, binary digits. Similar to the prior example, the translation metadata may be configured to indicate a state of an associated OS page as well as a storage location of each compressed OS page in an associated mem page. An OS page that contains all zeros may be indicated by a translation metadata value configured to indicate state of 0b000 and an OS page that is uncompressed may be indicated by a translation metadata value configured to indicate state of 0b111. A compressed OS page may be indicated by a translation metadata value in the range of 0b001 to 0b110. The location of the compressed OS page in the associated mem page may then be identified based, at least in part, on the specific value of the translation metadata between 0b001 and 0b110, inclusive. Thus, three binary digit translation metadata may identify up to six portions of an associated mem page. Similarly, four bit translation metadata may identify up to 14 portions of an associated mem page.

In an embodiment, translation metadata that includes three binary digits may be further configured to indicate whether a selected compressed OS page is compressed to one portion or more than one portion of the associated mem page. For example, a mem page may be configured to store up to three compressed OS pages. In this example, a portion of the mem page corresponds to one third of the mem page. A zero OS page, one, two or three compressed OS pages, an uncompressed OS page or a selected combination thereof may be stored to the corresponding mem page. Translation metadata of value 0b000 may then correspond to a zero OS page. Translation metadata of value 0b111 may then correspond to an uncompressed OS page. Translation metadata in the range 0b001 to 0b110 may then be configured to indicate whether the corresponding OS page is compressed to one portion, i.e., one third, or two portions, i.e., two thirds, of the mem page and to further indicate a stored location of the compressed OS page, i.e., a specific portion of the mem page. For example, translation metadata values 0b001, 0b010 or 0b100 may indicate that the OS page is compressed to one third of the mem page and may further indicate a stored location corresponding to a first portion, a second portion or a third portion, respectively, of the mem page. Continuing with this example, 0b101 and 0b110 may indicate that the OS page is compressed to two thirds of the mem page and may further indicate a stored location corresponding to a first and second portion, a first and third portion or a second and third portion, respectively, of the mem page.

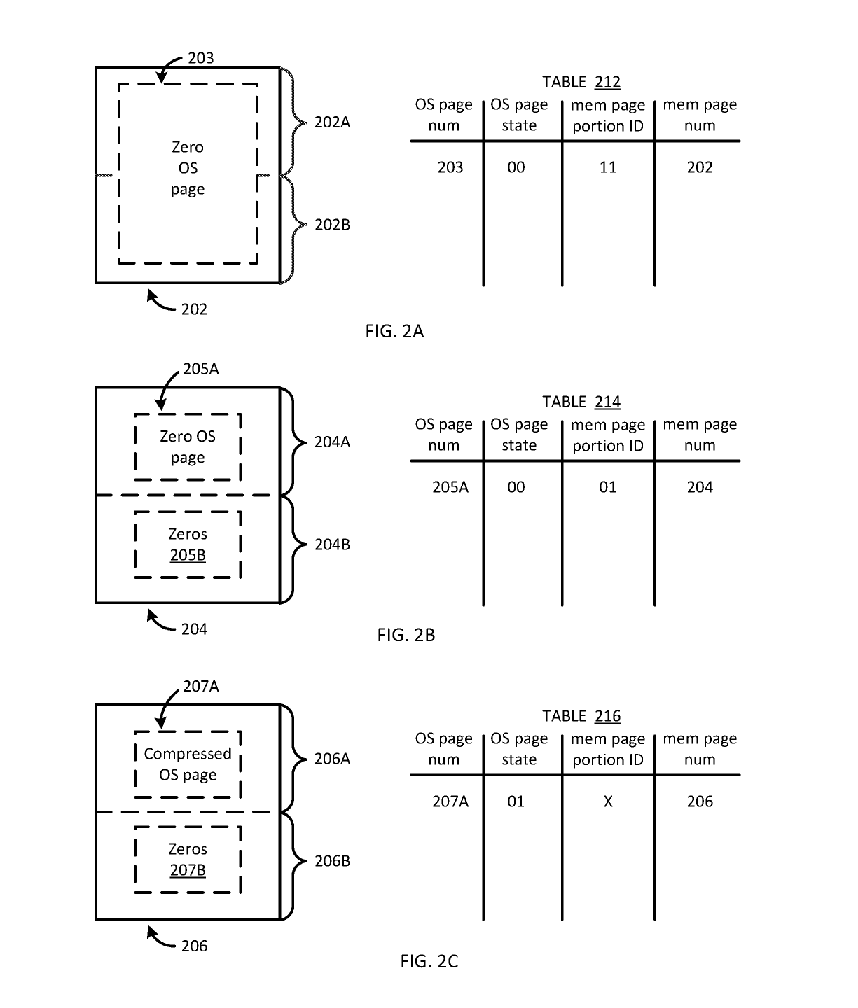

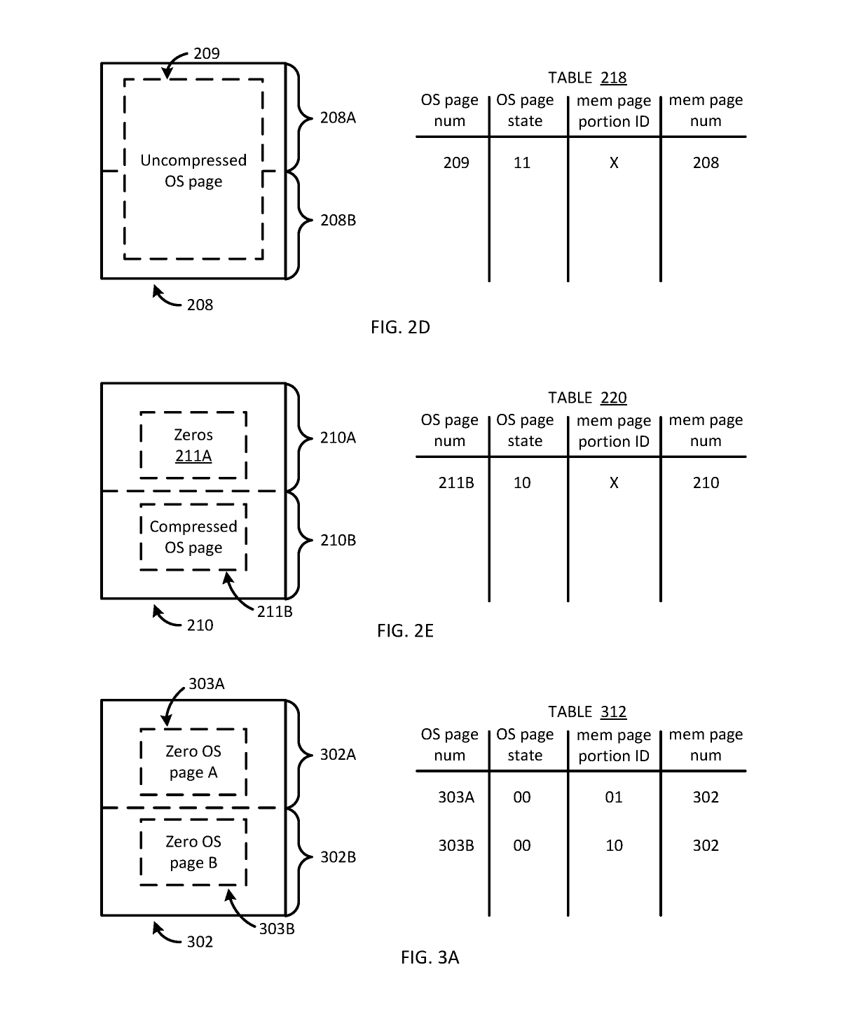

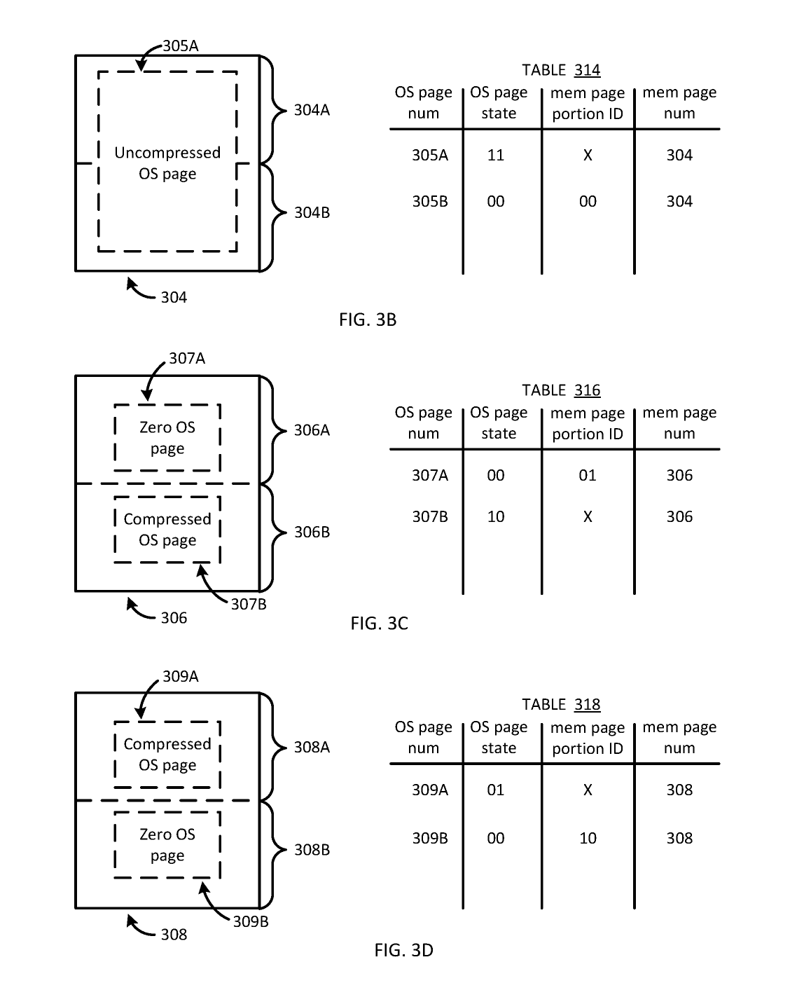

FIGS. 2A through 2E are illustrative examples illustrating one OS page stored to one mem page. FIGS. 3A through 3D are illustrative examples illustrating one zero OS page and one other OS page stored to one mem page. FIGS. 4A and 4B are illustrative examples illustrating two OS pages stored to one mem page and further illustrating one field indicating OS page state or OS page state and mem page portion ID. Thus, for a target compression ratio of 2 to 1, a mem page may contain one OS page, two compressed OS pages or one zero OS page and one other OS page. If the mem page contains one uncompressed OS page, a zero OS page may also be mapped to the same mem page.

The illustrative examples are configured to illustrate example contents of a mem page and a corresponding example OS page to mem page mapping. The illustrative examples are further configured to illustrate a corresponding entry in an example translation data structure as a result of operations of, e.g., memory controller 104, as described herein. The translation data structure includes mapping data and translation metadata associated with the OS page and the mem page. The translation data structure is represented as a table that includes a plurality of fields with each field indicated by a respective column heading. The column headings include OS page number and mem page number. The column headings further include two fields indicating OS page state and mem page portion identifier (ID), respectively, or one field indicating both OS page state and mem page portion ID (if any). Each table may include one or more rows. For these illustrative examples, respective reference designators corresponding to a mem page or an OS page are utilized as a corresponding page number in the translation data structure entry. For ease of illustration, these examples correspond to a compression ratio of 2 to 1. In other words, each mem page may include two mem page portions, e.g., a top half and a bottom half. “Top” and “bottom” are configured to indicate respective mem page portions and, thus, do not represent relative physical position. Other compression ratios may be similarly implemented, consistent with the present disclosure. For compression ratios greater than 2 to 1, fields associated with OS page state and/or mem page portion ID may include at least two bits, as described herein.

Turning now to FIGS. 2A through 2E, FIGS. 2A through 2E each illustrate one OS page 203, 205A, 207A, 209, 211B stored to one mem page 202, 204, 206, 208, 210, respectively. Each mem page 202, 204, 206, 208, 210 includes a top half (i.e., portion) 202A, 204A, 206A, 208A, 210A and a bottom half 202B, 204B, 206B, 208B, 210B, respectively. FIGS. 2A through 2E each illustrate a respective translation data structure entry, e.g., Table 212, Table 214, Table 216, Table 218, Table 220. Each table 212, 214, 216, 218, 220 contains mapping data and translation metadata for the associated OS page and mem page.

Turning now to FIG. 2A, mem page 202 contains one zero OS page 203. Thus, mem page 202 may contain all zeros. In Table 212, the OS page number field contains 203, corresponding to the OS page number of the stored zero OS page 203. The OS page state field contains 0b00 corresponding to an OS page with state zero. The mem page portion ID field contains 0b11 corresponding to an entire mem page and not a mem page portion. The mem page number field contains 202, corresponding to the mem page number of mem page 202. Thus, mem page 202, in this example, contains one zero OS page, zero OS page 203.

Turning now to FIG. 2B, mem page 204 contains one zero OS page 205A stored to the top half 204A of mem page 204. A plurality of zeros 205B is stored to the bottom half 204B of the mem page 204. In other words, the bottom half 204B is unmapped with respect to OS page to mem page mapping. Mem page 204 may thus contain all zeros. In Table 214, the OS page number field contains 205A, corresponding to the OS page number of the stored zero OS page 205A. The OS page state field contains 0b00 corresponding to a zero OS page. The mem page portion ID field contains 0b01 corresponding to the top half 204A of mem page 204. The mem page number field contains 204, corresponding to the mem page number of mem page 204. Thus, mem page 204, in this example, contains one zero OS page, i.e., zero OS page 205A, in the top half and a plurality of zeros 205B in the bottom half. The plurality of zeros 205B may be configured to “erase” any leftover data that may have been stored in the bottom half related to, for example, prior unrelated memory access operations.

Turning now to FIG. 2C, mem page 206 contains one compressed OS page 207A stored to the top half 206A of mem page 206. A plurality of zeros 207B is stored to the bottom half 206B of the mem page 206. The bottom half 206B of mem page 206 may thus contain all zeros. In Table 216, the OS page number field contains 207A, corresponding to the OS page number of the stored compressed OS page 207A. The OS page state field contains 0b01 corresponding to a compressed OS page stored to the top half of the corresponding mem page 206. In this example, the mem page portion ID field may be a “don't care”, indicated by the “X” in Table 216. In other words, the mem page portion ID is included in the OS page state value in this example. The mem page number field contains 206, corresponding to the mem page number of mem page 206. Thus, mem page 206, in this example, contains one compressed OS page, i.e., OS page 207A, in the top half and a plurality of zeros 207B in the bottom half.

Turning now to FIG. 2D, mem page 208 contains one uncompressed OS page 209. In Table 218, the OS page number field contains 209, corresponding to the OS page number of the stored uncompressed OS page 209. The OS page state field contains 0b11 corresponding to an OS page with state uncompressed. In this example, the mem page portion ID field may be a “don't care”, indicated by the “X” in Table 218. In other words, the OS page state value that corresponds to uncompressed further indicates that the stored OS page is configured to occupy the entire mem page. The mem page number field contains 208, corresponding to the mem page number of mem page 208. Thus, mem page 208, in this example, contains one uncompressed OS page, OS page 209.

Turning now to FIG. 2E, mem page 210 contains one compressed OS page 211B stored to the bottom half 210A of mem page 210. A plurality of zeros 211A is stored to the top half 210A of the mem page 210. The top half 210A of mem page 210 may thus contain all zeros. In Table 220, the OS page number field contains 211B, corresponding to the OS page number of the stored compressed OS page 211B. The OS page state field contains 0b10 corresponding to a compressed OS page stored to the bottom half of the corresponding mem page 210. In this example, the mem page portion ID field may be a “don't care”, indicated by the “X” in Table 220. In other words, similar to mem page 206 and Table 216 of FIG. 2C, the mem page portion ID is included in the OS page state value in this example. The mem page number field contains 210, corresponding to the mem page number of mem page 210. Thus, mem page 210, in this example, contains one compressed OS page, i.e., OS page 211B, in the bottom half and a plurality of zeros 211A in the top half.

Thus, FIGS. 2A through 2E illustrate a variety of examples of one OS page stored to one mem page. In some examples, a mem page portion that does not have an OS page mapped to it may store zeros without a corresponding entry in the translation data structure.

Turning now to FIGS. 3A through 3D, FIGS. 3A through 3D each illustrate one zero OS page 303A, 305B, 307A, 309B and one other OS page 303B, 305A, 307B, 309B mapped and/or stored to one mem page 302, 304, 306, 308, respectively. Each mem page 302, 304, 306, 308 includes a top half 302A, 304A, 306A, 308A and a bottom half 302B, 304B, 306B, 308B, respectively. FIGS. 3A through 3D each illustrate a respective translation data structure entry, e.g., Table 312, Table 314, Table 316, Table 318. Each table 312, 314, 316, 318 contains mapping data and translation metadata for the associated OS page(s) and mem page. Each table 312, 314, 316, 318 includes two table entries (i.e., rows) with each row corresponding to a respective OS page.

Turning now to FIG. 3A, mem page 302 contains two zero OS pages, including zero OS page A 303A stored to the top half 302A and zero OS page B 303B stored to the bottom half 302B. In the first row in Table 312, the OS page number field contains 303A, corresponding to the OS page number of the stored zero OS page A 303A. The first row OS page state field contains 0b00 corresponding to a zero OS page. The first row mem page portion ID field contains 0b01 corresponding to the top half 302A of mem page 302. The first row mem page number field contains 302, corresponding to the mem page number of mem page 302. Similarly, in the second row in Table 312, the second row OS page number field contains 303B, corresponding to the OS page number of the stored zero OS page B 303B. The second row OS page state field contains 0b00 corresponding to a zero OS page. The second row mem page portion ID field contains 0b10 corresponding to the bottom half 302B of mem page 302.The mem page number field contains 302, corresponding to the mem page number of mem page 302. Thus, mem page 302, in this example, contains a first zero OS page 303A and a second zero OS page 303B, stored to respective mem page portions.

Turning now to FIG. 3B, mem page 304 contains one uncompressed OS page 305A. In addition, one zero OS page is mapped to mem page 304, as illustrated by the second row in Table 314. In the first row in Table 314, the OS page number field contains 305A, corresponding to the OS page number of the stored uncompressed OS page 305A. The OS page state field contains 0b11 corresponding to an OS page with state uncompressed. In this example, the mem page portion ID field may be a “don't care”, indicated by the “X” in Table 314. In other words, the OS page state value that corresponds to uncompressed further indicates that the stored OS page is configured to occupy the entire mem page. The mem page number field contains 304, corresponding to the mem page number of mem page 304. In this example, a second row in the Table 314 corresponds to a zero OS page that is mapped to mem page 304 but not actually stored to mem page 304. In the second row, the OS page number field contains 305B, corresponding to the OS page number of the mapped zero OS page 305B. The OS page state field contains 0b00 corresponding to an OS page with state zero. In this example, the mem page portion ID field may contain 0b00 corresponding to a mapped zero OS page that is not stored to the corresponding mem page 304. The mem page number field contains 304, corresponding to the mem page number of mem page 304. Thus, mem page 304, in this example, contains one uncompressed OS page, OS page 305A, and has one zero OS page 305B mapped to it in corresponding translation data. Thus, two OS pages may be accommodated by one mem page when one of the OS pages is uncompressed and the other OS page is zero.

Turning now to FIG. 3C, mem page 306 contains one zero OS page 307A stored to the top half 306A and one compressed OS page 307B stored to the bottom half 306B. In the first row in Table 316, the OS page number field contains 307A, corresponding to the OS page number of the stored zero OS page 307A. The first row OS page state field contains 0b00 corresponding to a zero OS page. The first row mem page portion ID field contains 0b01 corresponding to the top half 306A. The first row mem page number field contains 306, corresponding to the mem page number of mem page 306. In the second row in Table 316, the OS page number field contains 307B, corresponding to the OS page number of the stored compressed OS page 307B. The second row OS page state field contains 0b10 corresponding to a compressed OS page stored to a bottom half of a corresponding mem page. The second row mem page portion ID field may be a don't care. In other words, similar to mem page 206 and Table 216 of FIG. 2C, the mem page portion ID is included in the OS page state value in this example. The second row mem page number field contains 306, corresponding to the mem page number of mem page 306. Thus, mem page 306, in this example, contains one zero OS page 307A in the top half and one compressed OS page, i.e., OS page 307B, in the bottom half.

Turning now to FIG. 3D, mem page 308 contains one compressed OS page 309A stored to the top half 308A and a zero OS page 309B stored to the bottom half 308B. In the first row in Table 318, the OS page number field contains 309A, corresponding to the OS page number of the stored compressed OS page 309A. The first row OS page state field contains 0b01 corresponding to a compressed OS page stored to a top half of a corresponding mem page. The first row mem page portion ID field may be a don't care. In other words, similar to mem page 206 and Table 216 of FIG. 2C, the mem page portion ID is included in the OS page state value in this example. The first row mem page number field contains 308, corresponding to the mem page number of mem page 308. In the second row in Table 318, the OS page number field contains 309B, corresponding to the OS page number of the stored zero OS page 309B. The second row OS page state field contains 0b00 corresponding to a zero OS page. The second row mem page portion ID field contains 0b10 corresponding to the bottom half 308B. The second row mem page number field contains 306, corresponding to the mem page number of mem page 306. Thus, mem page 308, in this example, contains one compressed OS page 309A in the top half and one zero OS page, i.e., OS page 309B, in the bottom half.

Thus, FIGS. 3A through 3D illustrate a variety of examples of one zero OS page and one other OS page stored to one mem page. Entries in a corresponding translation data structure are configured to include the mapping data and translation metadata, including a state of each OS page and, for each OS page mapped to and/or contained in a mem page portion, a mem page portion identifier. In some examples, the OS page state indicator and mem page portion identifier may correspond to the same field, i.e., the same bit sequence. In some examples, the OS page state indicator and the mem page portion identifier may correspond to respective fields, i.e., respective bit sequences. Thus, a plurality of OS pages may be mapped to and/or stored to one mem page.

Turning now to FIGS. 4A and 4B, FIGS. 4A and 4B each illustrate a first OS page 403A, 405A and a second OS page 403B, 405B mapped and/or stored to one mem page 402, 404, respectively. Each mem page 402, 404 includes a top half 402A, 404A and a bottom half 402B, 404B, respectively. FIGS. 4A and 4B each illustrate a respective translation data structure entry, e.g., Table 412, Table 414. Each table 412, 414 contains mapping data and translation metadata for the associated OS page(s) and mem page. Each table 412, 414 includes two table entries (i.e., rows) with each row corresponding to a respective OS page. In these illustrative examples, the tables 412, 414 each include three columns corresponding to three fields: OS page number, mem page number and a third field. The third field is configured to contain a bit sequence that corresponds to an OS page state indicator or both the OS page state indicator and a mem page portion identifier. In other words, the third field is configured to contain a bit sequence that corresponds to an OS page state indicator or, if the OS page is contained in a mem page portion, to an OS page state indicator and a mem page portion identifier.

Turning now to FIG. 4A, mem page 402 contains one uncompressed OS page 403B. In addition, one zero OS page 403A is mapped to mem page 402, as illustrated by the first row in Table 412. Thus, the first row in the Table 412 corresponds to a zero OS page that is mapped to mem page 402 but not actually stored to mem page 402. In the first row, the OS page number field contains 403A, corresponding to the OS page number of the mapped zero OS page 403A. The third field, i.e., the OS page state and mem page portion ID field, contains 0b00 corresponding to an OS page with state zero. In this example, the mem page portion ID is not included. The mem page number field contains 402, corresponding to the mem page number of mem page 402. In the second row in Table 412, the OS page number field contains 403B, corresponding to the OS page number of the stored uncompressed OS page 403B. The third field contains 0b11 corresponding to an OS page with state uncompressed. In this example, a mem page portion ID is not included. In other words, the OS page state and mem page portion ID field value that corresponds to uncompressed further indicates that the stored OS page is configured to occupy the entire mem page. The mem page number field contains 402, corresponding to the mem page number of mem page 402. Thus, mem page 402, in this example, contains one uncompressed OS page, OS page 403B, and has one zero OS page 403A mapped to it in corresponding translation data. Thus, two OS pages may be accommodated by one mem page when one of the OS pages is uncompressed and the other OS page is zero.

Turning now to FIG. 4B, mem page 404 contains a first compressed OS page 405A stored to the top half 404A and a second compressed OS page 405B stored to the bottom half 404B. In the first row and the second row in Table 414, the OS page number field contains 405A and 405B, respectively, corresponding to the OS page number of the each compressed OS page 405A, 405B. The mem page number fields in both the first row and the second row contain 404, corresponding to mem page 404 that contains both compressed OS pages 405A, 405B. In the first row, the third field, i.e., the OS page state and mem page portion ID field, contains 0b01 indicating that the first OS page 405A is compressed to the top half of mem page 404. In the second row, the third field contains 0b10 indicating that the second OS page 405B is compressed to the bottom half of mem page 404. Thus, mem page 404 contains two compressed OS pages 405A, 405B and the third field (i.e., OS page state indicator and mem page portion identifier field) is configured to indicate both the state of a corresponding OS page and identify the mem page portion (if any) that contains the corresponding OS page.

Thus, FIGS. 2A through 2E illustrate one OS page stored to one mem page, FIGS. 3A through 3D illustrate one zero OS page and one other OS page stored to one mem page and FIGS. 4A and 4B illustrate two OS pages mapped and/or stored to one mem page. FIGS. 4A and 4B further illustrate a third field that includes both an OS page state indicator and a mem page portion identifier, if any. Thus, for a target compression ratio of 2 to 1, a mem page may contain one OS page, two compressed OS pages or one zero OS page and one other OS page. If the mem page contains one uncompressed OS page, a zero OS page may also be mapped to the mem page. The illustrative examples are configured to illustrate contents of a mem page, OS page to mem page mapping and translation metadata that includes one field or more than one field. The illustrative examples are further configured to illustrate a corresponding entry in an example translation data structure as a result of operations of, e.g., memory controller 104, as described herein. The translation data structure includes mapping data and translation metadata associated with the OS page and the mem page. The translation metadata may include one field that corresponds to both an OS page state indicator and a mem page portion ID, if any, or a plurality of fields with one field corresponding to an OS page state indicator and one or more field(s) corresponding to mem page portion identifier(s) and/or the alternative storage device.

During operation, translation module 160 is configured to allocate the translation data structure 162, to utilize the translation data structure 162 for mapping, storing and retrieving OS page contents to and/or from respective mem pages and mem page portions, as described herein. Translation module 160 may be further configured to update the translation data structure 162 as mapping data and/or associated translation metadata changes, e.g., an OS page that was compressed is no longer compressible or a zero OS page is modified to include non-zero data.

The translation module 160 may thus be configured to analyze each OS page to determine whether the OS page contains all zeros, is compressible or is uncompressible. If the OS page is compressible, the translation module 160 is configured to trigger compression logic 168 to compress the OS page. Determining the initial storage location includes identifying a target mem page (i.e., target mem page number) and may include identifying a mem page portion. In one example, a target mem page number may correspond to an OS page number. In another example, the target mem page number may not correspond to the OS page number. An uncompressed OS page may be stored to a selected mem page. A compressed OS page may be stored to an identified (e.g., selected) portion of a target mem page. An OS page that contains all zeros may or may not be mapped to at least a portion of a selected mem page.

The portion of the target mem page may be selected deterministically or pseudo randomly. In one example, a low order portion of the target mem page may be selected. In another example, for a configuration where each mem page is configured to store up to two compressed OS pages, a low order portion of the mem page may be selected for storing a first compressed OS page and then a high order portion may be selected to store a next compressed OS page. Fragmentation may thus be reduced.

In another example, the target mem pages and target portion(s) may be selected to reduce and/or minimize fragmentation. In other words, a first target mem page that has an available portion may be selected. For example, a search for a target mem page may begin with a lowest mem page number. In another example, a hash table may be utilized that groups mem page numbers according to a corresponding storage status of each associated mem page. Storage status includes unallocated, fully allocated and partially allocated. The group of mem page number(s) whose storage status is partially allocated may be further divided into subgroups according to a specific mem page portion that is allocated. A partially allocated mem page may thus contain at least one OS page. Thus, selecting a mem page with available capacity may include a limited search that includes accessing an appropriate hash bucket to determine and/or identify an available mem page and/or mem page portion.

Thus, a search technique configured to identify a mem page with at least one portion available for storing a selected OS page may be implemented by translation module 160. The specific search technique implemented may be configured to search translation data structure 162 and/or a related auxiliary structure. Search techniques may include, but are not limited to, exhaustive, limited, random, etc. Search technique(s) may be supported by one or more auxiliary structures where the OS page numbers and/or mem page numbers are sorted. For example, an auxiliary structure may include inverse mapping data 163b. In another example, the auxiliary structure may include a linked list of all mem pages. In another example, a hash table may be utilized.

The search technique utilized may be related to characteristics of the data structure searched. For example, a search of a hash table may be a limited search. In another example, a search of a linked list may be generally exhaustive, i.e., the linked list is traversed until an appropriate mem page is identified. For example, utilizing a hash table, and for two bit translation metadata, i.e., each mem page may store up to two OS pages, the hash table may include four hash buckets. A mem page number may be related to a selected hash bucket based, at least in part, on whether the associated mem page currently stores one compressed OS page to a first portion or a second portion of the mem page, stores an uncompressed OS page or is mapped to a zero OS page. Mem pages that store two compressed OS pages or store an uncompressed OS page and have a zero OS page mapped to them are not in the hash table. Thus, an available mem page may be identified by accessing an appropriate hash bucket.

Thus, boot operations may include, for each OS page loaded into memory 106, determining an initial state of the OS page, determining an initial storage location of the OS page, compressing a compressible OS page, storing the possibly compressed OS page to at least a portion of a selected mem page and updating the translation metadata 164 and mapping data 163 associated with the OS page in the translation data structure 162. In some embodiments, if the contents of the OS pages exceed the capacity of the actual physical memory, then the excess OS pages may be stored to translation storage portion 152 of SSD 140, as described herein. In some embodiments, at least a subset of the excess OS pages may be stored to victim cache 156. Victim cache 156 may be configured to provide temporary storage for victim OS pages prior to writing the evicted OS pages to alternative storage, e.g., SSD 140.

In the case of zero OS pages, i.e., OS pages that contain only zeros, a selected zero OS page may or may not be mapped to at least a portion of a mem page. If the zero OS page is not mapped to a mem page, the translation data structure 162 may include a corresponding OS page number and translation metadata that corresponds to a zero page. If the zero OS page is mapped to at least a portion of a mem page, the translation data structure 162 may include mapping data (i.e., OS page number and mem page number) and translation metadata, as described herein. Mapping the zero OS page to at least a portion of a mem page may facilitate later updates to the OS page that include storing non-zero data to the at least a portion of the mem page.

Thus, at the completion of the boot operations, a mem page may contain one OS page or a plurality of OS pages. For a mem page that contains one OS page, the one OS page may be all zeros, may be compressed to a portion of the mem page with a remainder of the mem page containing all zeros or may be uncompressed. In one example, for a mem page that contains a plurality of OS pages, the plurality of OS pages may include at least one zero OS page and at least one other OS page of any state. In a system configured to store at most two OS pages to a mem page, if the other OS page is uncompressed, the zero OS page may be mapped to the mem page in associated mapping data. In other words, although the zero page is mapped to the mem page, the mem page may not necessarily include zeros. In another example of a mem page that contains a plurality of OS pages, each OS page of the plurality of OS pages may be compressed, with each compressed OS page stored to a respective portion of the mem page.

In operation, a selected OS page may be read from and/or written to. A read operation may further include decompressing a compressed OS page or a portion of the compressed OS page. A write operation may further include compressing an OS page or a portion of the OS page. Read and/or write operations targeted to OS pages and/or OS page portions that are included in cache, e.g., cache 122, may not trigger operation of translation module 160 since memory 106 is not accessed. Read and/or write operations targeted to OS pages that are not included in cache 122 are configured to trigger operation of translation module 160 and corresponding translation operations.

The translation operations performed may be selected based, at least in part, on a current state of a selected OS page (i.e., target OS page) and a next state of the selected OS page. For example, for a write operation, translation module 160 may be configured to determine a current state of a target OS page and to determine (e.g., identify) a current storage location of the target OS page. Translation module 160 may be configured to access the translation data structure 162 to determine both the current state and the current storage location. For example, the current state may be determined based, at least in part, on the translation metadata 164 and the current location may be determined based, at least in part, on the mapping data, e.g., forward mapping data 163a, as described herein. Translation module 160 may then be configured to determine a next state of the target OS page and a next storage location of the target OS page. The next storage location may be related to the current state, the current storage location and/or the next state of the target OS page.

For example, translation module 160 may be configured to receive a current OS page number that corresponds to the OS page (i.e., target OS page) being written to by the OS 124 and/or processor 102. Translation module 160 may then be configured to utilize the current OS page number as an index into translation data structure 162. For example, the current OS page number may be used as an index into forward mapping data 163a and/or translation metadata 164. A current state of the target OS page may be determined based, at least in part, on the current OS page translation metadata, i.e., the translation metadata entry associated with the target OS page number. The current state of the target OS page may be zero, compressed or uncompressed, as described herein.

If a target OS page is written to, then a current mem page associated with the target OS page may be identified. The identity of the current mem page corresponds to the mem page number of the current mem page. The current mem page number may be determined based, at least in part, on mapping data 163, e.g., forward mapping data 163a. For example, the target OS page may be used as an index into forward mapping data 163a and the corresponding current mem page number associated with the target OS page number may be identified. The current mem page number may then be utilized to determine whether any other OS page(s) are associated with, i.e., stored to, the current mem page. For example, the current mem page number may be used as an index into inverse mapping data 163b and the corresponding other OS page number(s), if any, associated with the current mem page number may be determined. If other OS page(s) are associated with the current mem page, then the state(s) of the other OS page(s) may be determined based, at least in part, on their associated translation metadata, as described herein. It should be noted that examples that include an alternative storage device, e.g., victim cache 156 and/or nonvolatile storage 112, are described below. In such example, the metadata in the translation data structure 162, e.g., in mapping data 163, is configured to indicate that an OS page is mapped to an alternative storage device, and the mapped location on the alternative storage device may also be included in the translation data structure 162.

Translation module 160 may then be configured to determine a next state of the target OS page. The next state may be determined based, at least in part, on whether the contents of the target OS page (and/or target OS page portion) are compressible or zero. If the contents are compressible, then the next state is compressed. If the contents are zero, then the next state is zero. If the contents are not compressible, then the next state is uncompressed. If the target OS page (or OS page portion) is compressible, then translation module 160 may be configured to trigger compression logic 168 to compress the target OS page and/or target OS page portion.

For example, if the current state is zero and the data being written is nonzero, a next storage location of the target OS page may be determined. The next storage location is related to the next state of the target OS page and the state(s) of the other OS page(s), if any. If the current mem page contains an uncompressed other OS page or the current mem page contains at least one compressed other OS page and the next state of the target OS page is uncompressed, then the next storage location may not be the current mem page. If the current mem page contains fewer other OS pages than available mem page portions, the respective state of each other OS page is zero or compressed and the next state of the target OS page is compressed, then the next storage location may be the current mem page. If the next storage location is the current mem page, then the target OS page may be compressed and stored to the current mem page in an available portion. The corresponding translation metadata entry (including a corresponding mem page portion identifier) may then be updated.

If the next storage location is not the current mem page, then translation module 160 may be configured to identify a next mem page that has available space. For example, translation module 160 may be configured to search translation data structure 162 and/or an auxiliary data structure to identify at least one mem page that has sufficient available space to store the target OS page. Whether a prospective mem page has sufficient space available may be determined based, at least in part, on the next state of the target OS page (e.g., compressed or uncompressed) and based, at least in part, on whether any other OS page(s) are currently stored to the prospective mem page and the respective state(s) of any stored other OS page(s). A prospective mem page with sufficient space available may then be selected, the target OS page may be compressed, if compressible, and stored to the selected mem page. Corresponding mapping data and corresponding translation metadata may then be updated.

In another example, if the current state is compressed and the next state is also compressed, the target OS page and/or target OS page portion may be compressed and stored to the current mem page portion identified using mapping and data 163 and translation metadata 164. The mapping data entry and translation metadata entry may be unchanged.

In another example, if the current state is compressed and the next state is uncompressed, the next storage location may not be the current mem page. Translation module 160 may then be configured to determine a next storage location, as described herein. For example, the next storage location may be a mem page that is unused or a mem page that contains or has mapped to it a zero OS page (i.e., an OS page that is in the zero state). The target OS page contents may then be decompressed and stored to the next storage location. The corresponding translation data (i.e., mapping data and translation metadata) entries may then be updated.

In another example, if the current state is uncompressed and the next state is compressed, the target OS page may be compressed and stored to the current mem page in a selected mem page portion. The mem page portion may be selected deterministically or pseudo randomly. The associated mapping data entry may be unchanged. The associated translation metadata may be updated to indicate compressed and to include the mem page portion identifier.

In another example, if the current state is compressed or uncompressed and the next state is zero, the next storage location may be the same as the current storage location. The storage location may be identified using translation data included in translation data structure 162, as described herein. The associated mapping data entries may remain unchanged and the associated translation metadata may be updated to indicate the zero state.

Thus, a target OS page may be written to and, as a result, an associated state of the OS page may or may not change. Translation data structure 162 may then be utilized to determine a current state and current location of the target OS page. A next state may be determined and a next storage location may be determined based, at least in part, on the next state. The target OS page contents may be updated and stored to the next storage location. The associated entries in the translation data structure may then be updated.

In some situations, when a next storage location is different from a current storage location, a mem page or mem page portion may not be available for storing a target OS page. In such situations, translation module 160 may be configured to utilize an alternative storage device, for example, nonvolatile storage 112 (e.g., SSD 140) and/or victim cache 156. Similar to handling a page fault by an OS, the translation module 160 may be configured to identify one or more “victim” OS page(s) to be silently evicted from main memory and stored to the alternative storage device. As used herein, silent eviction means removed from main memory and stored to an alternative storage device without notifying the OS 124 that the OS page is no longer stored in main memory. Victim OS page(s) may be identified based, at least in part, on one or more heuristics. OS pages that are relatively more likely to be selected as victim OS pages may have one or more of the following characteristics: they are clean, they have not been accessed for a relatively long time (i.e., least recently used (LRU)) and they are uncompressed. As used herein, “clean” means that the OS page contents have not been modified since they were first stored in memory from nonvolatile storage. In other words, the OS page contents exist in nonvolatile storage.

In an embodiment, victim OS page(s) may be stored to translation storage portion 152 of SSD 140. Translation module 116 may be configured to provide one or more victim OS pages to SSD 140 for storage to translation storage portion 152. For example, SSD controller 146 may be configured to manage storing the victim OS pages to the translation storage portion 152. SSD controller 146 may be configured to provide a mapping between each victim OS page number and an associated SSD storage location. SSD controller 146 may be further configured to erase associated SSD storage locations upon shutdown and/or power failures. For example, erasing may include storing all zeros or all ones. In another example, erasing may include changing a key associated with encrypted stores OS page contents. In other words, SSD controller 146 may be configured to manage translation storage portion 152 so that translation storage portion 152 operates as volatile storage. Such operation is configured to provide a measure of security so that information perceived by the OS 124 as being stored to memory 106 does not survive a shutdown or a power failure.

In another embodiment, victim OS page(s) may be temporarily stored to victim cache 156. Translation module 160 may be configured to store victim OS page(s) to victim cache 156 prior to evicting them to nonvolatile storage 112. If a victim OS page is then accessed prior to being evicted, the victim OS page may be recovered from the victim cache 156. If a victim OS page is not accessed and it is compressed, translation module 160 is configured to trigger compression logic 168 to decompress the victim OS page prior to evicting, i.e., storing the OS page to nonvolatile storage 112

Thus, OS page(s) that do not fit in memory may be accommodated. Storing OS page(s) to SSD 140 may result in a relatively smaller latency compared to storing to, e.g., HDD 142. The latency may be further reduced by SSD technology that has relatively shorter access times, e.g., three-dimensional crosspoint technology.

OS 124 and/or processor 102 may initiate read operations of OS page(s) and/or portion(s) of an OS page. Similar to the write operations described herein, translation module 160 is configured to determine a current state of a target OS page and to determine a current storage location of the target OS page utilizing the translation data structure 162 and the target OS page number as an index. If the state of the target OS page is compressed, the translation module 160 is configured to trigger the compression logic 168 to decompress the target OS page and/or target OS page portion prior to providing the read contents to OS 124 and/or processor 102. If the target OS page is located in alternative storage, e.g., translation storage portion 152, then translation module 160 is configured to request the target OS page from SSD controller 146.

As a result of OS 124 generally allocating more virtual memory to applications than the capacity of the OS visible memory, a virtual memory page may map to an OS page (target OS page) that is not present in the OS visible physical memory (i.e., a page fault may occur). In other words, the target OS page contents may be stored to nonvolatile storage 112. In this situation, translation module 160 is configured to identify a victim OS page to evict from memory, to store the victim OS page contents to nonvolatile storage, to read the target OS page contents from nonvolatile storage 112 and to store the target OS page contents to the evicted OS page location.

In an embodiment, translation module 160 is configured to determine a current state and a current storage location (i.e., mem page number) of the victim OS page, utilizing the translation data structure, as described herein. If the current state is compressed, the victim OS page contents may be decompressed by compression logic 168 prior to storage to nonvolatile storage 112 by, e.g., translation module 160. The target OS page contents may then be read from nonvolatile storage 112. Translation module 160 and/or compression logic 168 may then determine whether the target OS page contents are compressible. If the contents are compressible, compression logic 168 is configured to compress the target OS page contents.

Translation module 116 may then determine whether the target OS page will fit into the evicted OS page storage location. For example, if the respective states of the target OS page and the evicted OS page are the same, the translation data (i.e., mapping data and translation metadata) may remain unchanged and the target OS page contents may be stored to the evicted OS page storage location. In other words, the target OS page fits into the mem page storage location vacated by the evicted OS page. If the respective states of the target OS page and evicted OS page are not the same, the target OS page may or may not fit into the mem page storage location vacated by the evicted OS page. For example, if the victim OS page was uncompressed and the target OS page is compressed, then the target OS page may be stored to the mem page vacated by the evicted OS page. A mem page portion may be selected, as described herein, and the associated translation metadata may be updated to indicate OS page is compressed.

In another example, if the evicted OS page was compressed and the target OS page is uncompressed or the target OS page is compressed but is compressed to a compressed size greater than the compressed size of the evicted OS page, then the target OS page may not fit into the mem page storage location vacated by the evicted OS page. Similar to the write operations described herein, translation module 160 is configured to determine whether the target mem page that stored the evicted OS page contains other OS page(s) and/or whether the target mem page has space available to accommodate the target OS page. If the target mem page has sufficient space available, the target OS page contents may be stored to the target mem page and the associated translation metadata may be updated. If the target mem page does not have sufficient space available, translation module 160 may be configured to identify a next mem page that has space available, e.g., a mem page that has only zero state OS page(s) associated with it or an unused mem page. For example, a hash table may be used to identify the unused mem page, as described herein. If a mem page with available space is identified, the target OS page contents may be stored to the identified mem page and translation data (i.e., mapping data and translation metadata) may be updated accordingly. If a mem page with available space cannot be identified, then the target OS page may be stored to alternative storage, as described herein.

Thus, a page fault may be accommodated.

Thus, an apparatus, method and/or system are configured to map an OS page to at least a portion of a mem page or to an alternative storage device. Each OS page is configured to be interpreted by the OS as a physical memory page. The OS is unaware of the mapping of the OS page to at least a portion of a mem page or to the alternative storage device. The apparatus, method and/or system may compress one or more OS page(s), thus, allowing a plurality of OS pages to be stored to a single mem page. An OS visible memory capacity is greater than an actual physical memory (“main memory”) capacity, thus providing increased memory capacity without increasing actual memory size.

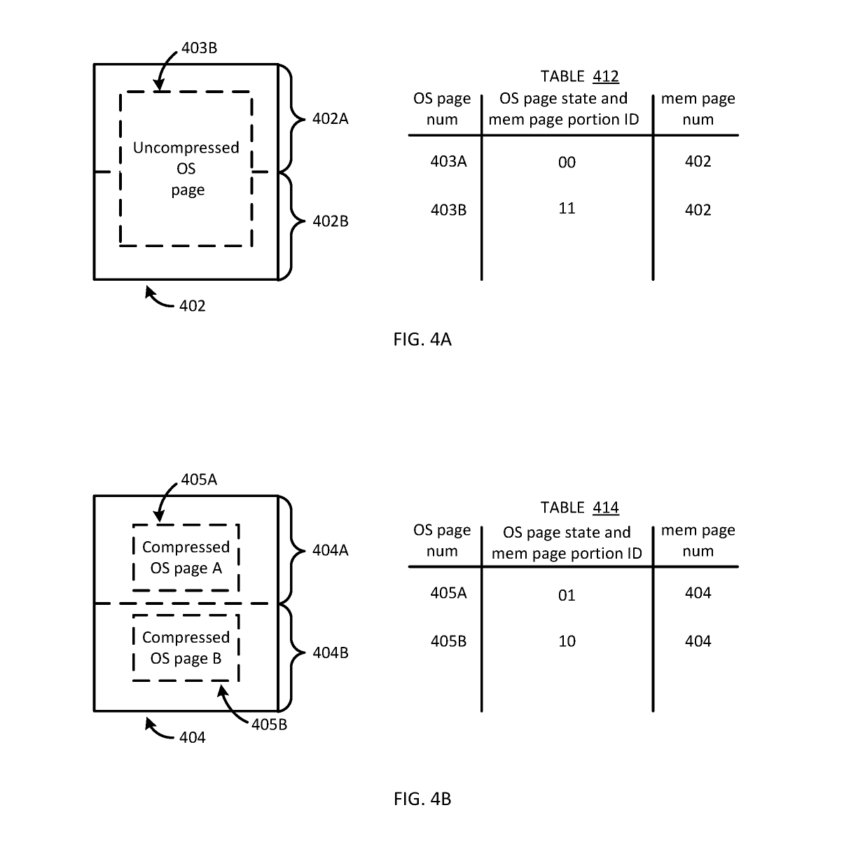

FIG. 5 is a flowchart 500 of boot operations according to various embodiments of the present disclosure. In particular, the flowchart 500 illustrates allocating and initializing a translation data structure. The operations may be performed, for example, by translation module 160 and/or compression logic 168 of FIG. 1.

Operations of this embodiment may begin with start 502. Operation 504 may include allocating a translation data structure. Operation 506 may include determining an initial state of an operating system (OS) page. Determining the initial state of the OS page may include compressing the OS page if it is compressible. An initial storage location of the OS page may be determined at operation 508. The OS page may be stored to an initial storage location at operation 510. In some situations, the OS page may not be stored to an initial storage location. For example, an OS page that contains all zeros, i.e., the state of the OS page is zero, may not be stored. Translation data (i.e., mapping data and/or translation metadata) may then be updated at operation 512. Program flow may then continue at operation 514.

Thus, a translation data structure may be allocated and initialized.

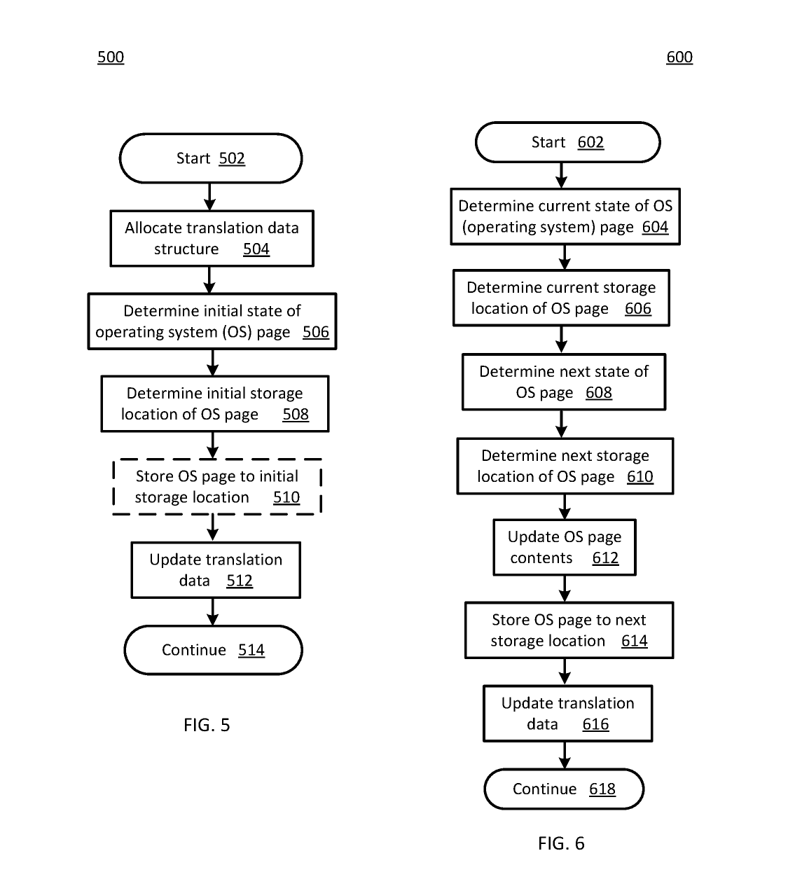

FIG. 6 is a flowchart 600 of increased memory capacity operations according to various embodiments of the present disclosure. In particular, the flowchart 600 illustrates determining a next state and next storage location of an OS page and updating the translation data structure based, at least in part, on the next state and/or based, at least in part, on the next storage location. The operations may be performed, for example, by translation module 160 and/or compression logic 168 of FIG. 1.

Operations of this embodiment may begin with start 602. A current state of an OS page may be determined at operation 604. A current storage location of the OS page may be determined (e.g., identified) at operation 606. A next state of the OS page may be determined at operation 608. The next state may be determined based, at least in part, on whether the OS page is compressible. A next storage location of the OS page may be determined at operation 610. The next storage location may be determined based, at least in part, on the next state of the OS page. Contents of the OS page may be updated at operation 612. For example, at least a portion of the contents may be compressed. The updated OS page may then be stored to the next storage location at operation 614. Translation data may then be updated at operation 616. Program flow may then continue at operation 618.

Thus, a next state and next storage location of an OS page may be determined and the translation data structure may be updated based, at least in part, on the next state and/or based, at least in part, on the next storage location.

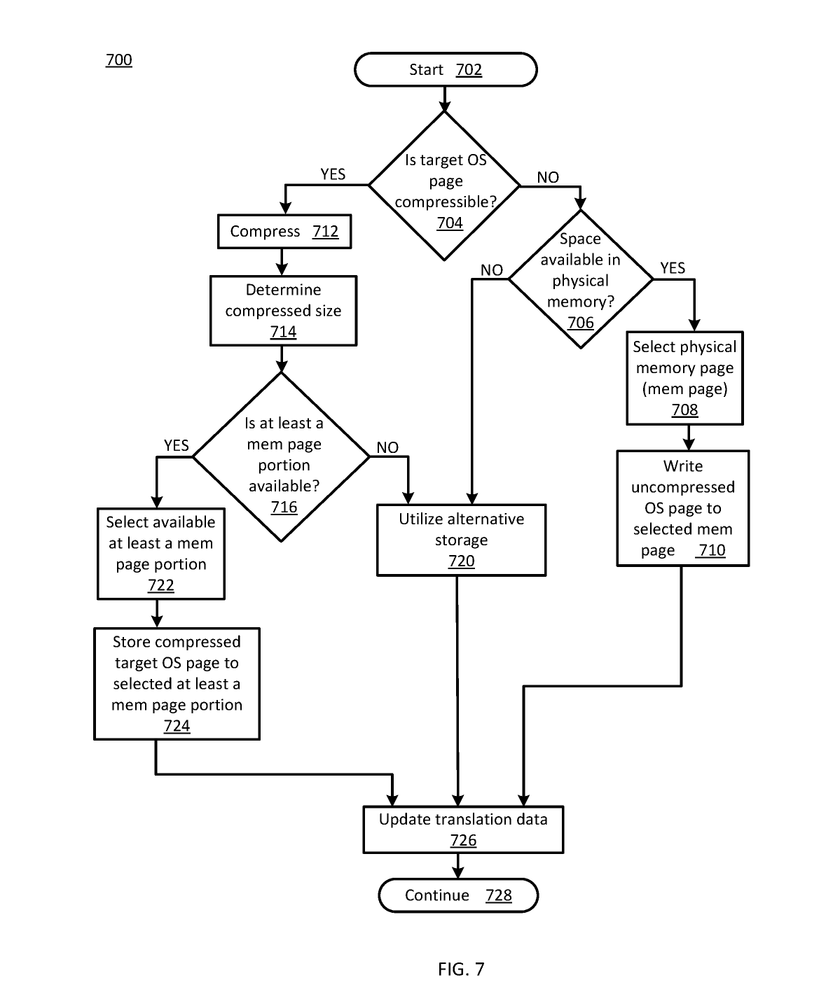

FIG. 7 is a flowchart 700 of write operations according to various embodiments of the present disclosure. In particular, the flowchart 700 illustrates determining a next state and next storage location of an OS page and updating the translation data structure based, at least in part, on the next state and/or based, at least in part, on the next storage location. The operations may be performed, for example, by translation module 160 and/or compression logic 168 of FIG. 1.

Operations of this embodiment may begin with start 702. Whether a target OS page is compressible may be determined at operation 704. If the target OS page is not compressible, whether there is space available in physical memory may be determined at operation 706. If there is space available in physical memory, then a physical memory page (mem page) may be selected at operation 708. The uncompressed target OS page may then be written to the selected mem page at operation 710. Translation data may then be updated at operation 726. Program flow may then continue at operation 728. If there is not space available in physical memory, then alternative storage may be utilized at operation 720. Program flow may then proceed to operation 726.

If the target OS page is compressible, then the target OS page may be compressed at operation 712. A size of the compressed target OS page may then be determined at operation 714. Whether at least a mem page portion is available may be determined at operation 716. If at least a mem page portion is not available, program flow may proceed to operation 720. If at least a mem page portion is available, available at least a mem page portion may be selected at operation 722. The compressed target OS page may then be stored to the selected at least a mem page portion at operation 724. Program flow may then proceed to operation 726.

Thus, a next state and next storage location of an OS page may be determined and the translation data structure may be updated based, at least in part, on the next state and/or based, at least in part, on the next storage location.

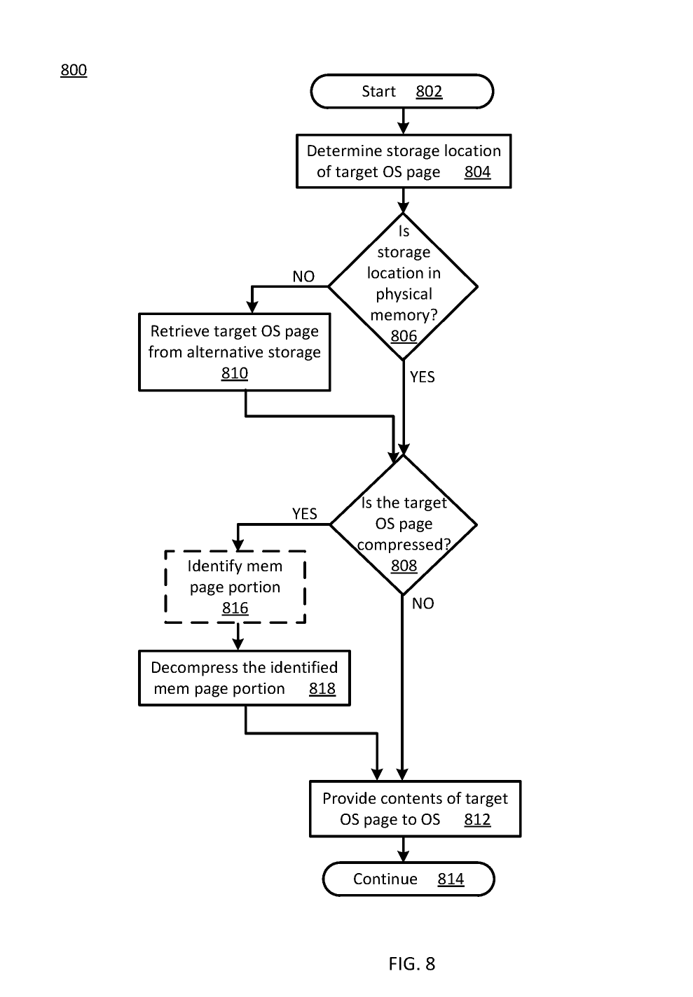

FIG. 8 is a flowchart 800 of read operations according to various embodiments of the present disclosure. In particular, the flowchart 800 illustrates determining a storage location of a target OS page and retrieving the target OS page from the determined storage location. The operations may be performed, for example, by translation module 160 and/or compression logic 168 of FIG. 1.

Operations of this embodiment may begin with start 802. A storage location of a target OS page may be determined at operation 804. Whether the storage location is in physical memory may be determined at operation 806. If the storage location is in physical memory whether the target OS page is compressed may be determined at operation 808. If the target OS page is not compressed, the contents of the target OS page may then be provided to an OS, e.g., OS 124, at operation 812. Program flow may then continue at operation 814.

If the target OS page is compressed, a mem page portion may be identified at operation 816. The identified mem page portion, i.e., the target OS page, may then be decompressed at operation 818. Program flow may then proceed to operation 812. If the storage location is not in physical memory, the target OS page may be retrieved from alternative storage at operation 810. Program flow may then proceed to operation 808.

Thus, a storage location of a target OS page may be determined and the target OS page may be retrieved from the determined storage location

While the flowcharts of FIGS. 5 through 8 illustrate operations according various embodiments, it is to be understood that not all of the operations depicted in FIGS. 5 through 8 are necessary for other embodiments. In addition, it is fully contemplated herein that in other embodiments of the present disclosure, the operations depicted in FIGS. 5, 6, 7, and/or 8 and/or other operations described herein may be combined in a manner not specifically shown in any of the drawings, and such embodiments may include less or more operations than are illustrated in FIGS. 5 through 8. Thus, claims directed to features and/or operations that are not exactly shown in one drawing are deemed within the scope and content of the present disclosure.

Generally, this disclosure relates to increased memory capacity. An apparatus, method and/or system are configured to map an operating system (OS) visible memory page (OS page) to at least a portion of an actual physical memory page (mem page) or to an alternative storage device. Each OS page is configured to be interpreted by the OS as a physical memory page. The OS is unaware of the mapping of the OS page to at least a portion of a mem page or to the alternative storage device. In other words, the mapping is transparent to the OS. The apparatus, method and/or system may compress one or more OS page(s), thus, allowing a plurality of OS pages to be stored to a single mem page. An OS visible memory capacity is greater than an actual physical memory (i.e., main memory) capacity, thus providing increased memory capacity without increasing actual physical memory size.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. For example, a module may include circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

The foregoing provides example system architectures and methodologies, however, modifications to the present disclosure are possible. The processor may include one or more processor cores and may be configured to execute system software. System software may include, for example, an operating system. Device memory may include I/O memory buffers configured to store one or more data packets that are to be transmitted by, or received by, a network interface.

The operating system (OS) 124 may be configured to manage system resources and control tasks that are run on, e.g., system 100. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units. The operating system and/or virtual machine may implement one or more protocol stacks. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network.

Memory 106 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), solid state drives (SSDs), flash memories, magnetic or optical cards, or any type of storage devices suitable for storing electronic instructions.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The

VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

### EXAMPLES

Examples of the present disclosure include subject material such as a method, means for performing acts of the method, a device, or of an apparatus or system related to increased memory capacity, as discussed below.

### Example 1

According to this example, there is provided an apparatus. The apparatus includes a translation module to map an operating system (OS) visible memory page (OS page) to at least a portion of an actual physical memory page (mem page) or to an alternative storage device. The OS page is interpreted by an OS as a physical memory page. An OS visible memory capacity is greater than an actual physical memory capacity.

### Example 2

This example includes the elements of example 1, wherein the translation module is further to determine a state of the OS page.

### Example 3

This example includes the elements of example 1, wherein the translation module is further to determine a storage location of the OS page.

### Example 4

This example includes the elements of example 1, further including compression logic to compress contents of at least a portion of the OS page.

### Example 5

This example includes the elements of example 1, further including a translation data structure to store mapping data and translation metadata related to the mapping of the OS page to the at least a portion of the mem page.

### Example 6

This example includes the elements of example 2, wherein the state is selected from the group including zero, compressed and uncompressed.

### Example 7

This example includes the elements according to any one of examples 1 through 5, wherein a plurality of OS pages is mapped to one mem page.

### Example 8

This example includes the elements of example 3, wherein the storage location is selected from the group including an identified mem page, an identified portion of the identified mem page and a translation storage portion of a solid state drive (SSD).

### Example 9

This example includes the elements according to any one of examples 1 through 5, wherein the OS visible memory capacity is related to the actual physical memory capacity by a capacity factor.

### Example 10

This example includes the elements of example 9, wherein the capacity factor is greater than one.

### Example 11

This example includes the elements of example 9, wherein the capacity factor is 1.5.

### Example 12

This example includes the elements according to any one of examples 1 through 5, wherein the OS visible capacity is related to the actual physical memory capacity and a capacity of the alternative storage device.

### Example 13

This example includes the elements according to any one of examples 1 through 5, wherein the mapping includes relating a first OS page number to a mem page number.

### Example 14

This example includes the elements of example 13, wherein the mapping further includes relating the mem page number to at least one OS page number, the at least one OS page number including the first OS page number.

### Example 15

This example includes the elements of example 5, wherein the mapping data includes forward mapping data, the forward mapping data relating the OS page to the mem page or to the alternative storage device.

### Example 16

This example includes the elements of example 15, wherein the mapping data further includes inverse mapping data for each mem page that stores at least one OS page, the inverse mapping data to identify each OS page of the at least one OS page.

### Example 17

This example includes the elements of example 5, wherein the translation metadata includes a state indicator corresponding to a state of the OS page.

### Example 18

This example includes the elements of example 17, wherein the state indicator is selected from the group including a zero page indicator, an uncompressed indicator and a compressed indicator.

### Example 19

This example includes the elements of example 18, wherein the zero page indicator is to indicate that a corresponding OS page contains only zeros, the uncompressed indicator is to indicate that the corresponding OS page is uncompressed and the compressed indicator is to indicate that the corresponding OS page is compressed.

### Example 20

This example includes the elements of example 18, wherein the translation metadata includes a mem page portion identifier if the state indicator is the compressed indicator.

### Example 21

This example includes the elements of example 20, wherein the compressed indicator and the mem page portion identifier correspond to a same bit sequence.

### Example 22

This example includes the elements of example 5, wherein the translation metadata includes a mem page portion identifier if a state of the OS page corresponds to compressed.

### Example 23

This example includes the elements of example 7, wherein the plurality of OS pages includes a zero OS page and an uncompressed OS page.

### Example 24

This example includes the elements of example 7, wherein each of the plurality of OS pages is compressed.

### Example 25

This example includes the elements of example 7, wherein the plurality of OS pages includes a zero OS page and a compressed OS page.

### Example 26

This example includes the elements of example 4, wherein the compression logic is to compress a selected OS page or a portion of the selected OS page prior to storing the selected OS page or selected OS page portion to a target portion of a target mem page.

### Example 27

This example includes the elements of example 26, wherein the compression logic is further to decompress the selected compressed OS page or the selected OS page portion as part of a read operation.

### Example 28

This example includes the elements of example 4, wherein the OS page is compressed and the compressed OS page has a corresponding compression ratio.

### Example 29

This example includes the elements of example 28, wherein the corresponding compression ratio is related to a target compression ratio.

### Example 30

This example includes the elements of example 29, wherein the target compression ratio is two to one.

### Example 31

This example includes the elements of example 5, wherein the translation metadata includes a plurality of binary digits, a number of binary digits related to a target compression ratio.

### Example 32

This example includes the elements of example 31, wherein the number of binary digits is two, the target compression ratio is two to one and the mem page is to store up to two compressed OS pages.

### Example 33

This example includes the elements of example 31, wherein the number of binary digits is greater than two, the target compression ratio is greater than two to one and the mem page is to store more than two compressed OS pages.

### Example 34

This example includes the elements according to any one of examples 1 through 5, wherein the translation module is further to determine whether a selected OS page is compressible.

### Example 35

This example includes the elements of example 4, wherein the compression logic is further to determine whether a selected OS page is compressible.

### Example 36

This example includes the elements of example 4, wherein the compression logic is to implement a selected compression technique, the selected technique having one or more associated characteristics.

### Example 37

This example includes the elements of example 36, wherein the compression technique associated characteristics include one or more of compression latency, decompression latency, compressibility, capacity, power consumed during compression, power consumed during decompression, compression and decompression logic circuitry area, compression and decompression circuitry idle power, compression and decompression block data size, dictionary size, data item granularity to detect redundancy or compressibility and data granularity for compressed data items.

### Example 38

This example includes the elements of example 36, wherein the selected compression technique is selected from the group including frequent pattern compression (FPC), base-delta-immediate compression (BDI), cache packer (CPACK) compression, run length encoding (RLE), Huffman encoding, Limpel-Ziv (LZ) compression and deflate compression.

### Example 39

This example includes the elements of example 4, further including a compression dictionary.

### Example 40

This example includes the elements of example 39, wherein the compression dictionary is to store one or more repeated data value(s) and/or a code for each data item such that the code for a relatively more frequent data item is shorter than a code for a relatively less frequent data item.

### Example 41

This example includes the elements of example 5, wherein the translation module is to determine based, at least in part, on the translation data structure, at least one of a current state of a target OS page, a current storage location of the target OS page, a next state of the target OS page and/or a next storage location of the target OS page.

### Example 42

This example includes the elements of example 41, wherein the determining the next storage location includes identifying a target mem page.

### Example 43

This example includes the elements of example 42, wherein the determining the next storage location further includes identifying a target mem page portion.

### Example 44

This example includes the elements of example 42, wherein the identifying includes searching the translation data structure or an auxiliary data structure.

### Example 45

This example includes the elements of example 44, wherein the auxiliary data structure is selected from the group including inverse mapping data, a linked list and a hash table.

### Example 46

This example includes the elements of example 41, wherein the translation module is to utilize a current OS page number as a first index into the translation data structure.

### Example 47

This example includes the elements of example 41, wherein the translation module is to determine a current mem page number.

### Example 48

This example includes the elements of example 47, wherein the translation module is to utilize the current mem page number as a second index into the translation data structure.

### Example 49

This example includes the elements of example 41, wherein the next storage location is related to the current state and the next state of the target OS page.

### Example 50

This example includes the elements of example 5, wherein the translation module is further to update one or more entries in the translation data structure.

### Example 51

This example includes the elements of example 5, wherein the translation module is to initialize the translation data structure.

### Example 52

This example includes the elements of example 51, wherein the initializing includes determining an initial state of each OS page, determining an initial storage location of each OS page, storing each nonzero OS page to a respective initial storage location and updating the mapping data and the translation metadata.

### Example 53

This example includes the elements of example 52, wherein the determining the initial state of each OS page includes determining whether a respective OS page is compressible and compressing each compressible OS page.

### Example 54

This example includes the elements of example 5, further including a translation cache to store at least a portion of one or more entries included in the translation data structure.

### Example 55

This example includes the elements according to any one of examples 1 through 5, further including a victim cache to store a victim OS page.

### Example 56

This example includes the elements of example 55, wherein the translation module is to identify the victim OS page.

### Example 57

This example includes the elements of example 56, wherein the identifying is based, at least in part, on one or more heuristic(s).

### Example 58

This example includes the elements of example 55, wherein the translation module is to store the victim OS page to the victim cache temporarily.

### Example 59

This example includes the elements of example 5, wherein the translation data structure is configured as a lookup table (LUT).

### Example 60

This example includes the elements of example 5, wherein the translation data structure is multilevel.

### Example 61

This example includes the elements of example 5, wherein the translation data structure utilizes a portion of a page table.

### Example 62

This example includes the elements according to any one of examples 1 through 5, wherein the mapping is performed in response to a memory access request that results in an OS memory access operation.

### Example 63

This example includes the elements of example 62, wherein the OS memory access operation is a read operation and the translation module is to determine based, at least in part, on the translation data structure, a current state of a target OS page and a current storage location of the target OS page.

### Example 64

This example includes the elements of example 63, wherein the read operation further includes decompressing the target OS page.

### Example 65

This example includes the elements of example 62, wherein the OS memory access operation is a write operation and the translation module is to determine based, at least in part, on the translation data structure, a current state of a target OS page, a current storage location of the target OS page, a next state of the target OS page and a next storage location of the target OS page.

### Example 66

This example includes the elements according to any one of examples 1 through 5, wherein the mapping is performed in response to a memory access request that results in a page fault.

### Example 67

This example includes the elements of example 66, wherein the translation module is further to identify a victim OS page to evict from memory.

### Example 68

This example includes the elements of example 67, wherein the translation module is to determine a current state and a current storage location of the victim OS page, utilizing a translation data structure.

### Example 69

According to this example, there is provided a method. The method includes mapping, by a translation module, an operating system (OS) visible memory page (OS page) to at least a portion of an actual physical memory page (mem page) or to an alternative storage device. The OS page is interpreted by an OS as a physical memory page. An OS visible memory capacity is greater than an actual physical memory capacity.

### Example 70

This example includes the elements of example 69, further including determining, by the translation module, a state of the OS page.

### Example 71

This example includes the elements of example 69, further including determining, by the translation module, a storage location of the OS page.

### Example 72

This example includes the elements of example 69, further including compressing, by compression logic, contents of at least a portion of the OS page.

### Example 73

This example includes the elements of example 69, further including storing, by a translation data structure, mapping data and translation metadata related to the mapping of the OS page to the at least a portion of the mem page.

### Example 74

This example includes the elements of example 70, wherein the state is selected from the group including zero, compressed and uncompressed.

### Example 75

This example includes the elements of example 69, wherein a plurality of OS pages is mapped to one mem page.

### Example 76

This example includes the elements of example 69, further including storing, by a basic input/output system (BIOS), an OS visible memory capacity value that corresponds to the OS visible memory capacity.

### Example 77

This example includes the elements of example 73, further including storing, by the translation module, at least a portion of the translation data structure to a translation lookaside buffer (TLB).

### Example 78

This example includes the elements of example 71, wherein the storage location is selected from the group including an identified mem page, an identified portion of the identified mem page and a translation storage portion of a solid state drive (SSD).

### Example 79

This example includes the elements of example 69, wherein the OS visible memory capacity is related to the actual physical memory capacity by a capacity factor.

### Example 80

This example includes the elements of example 79, wherein the capacity factor is greater than one.

### Example 81

This example includes the elements of example 79, wherein the capacity factor is 1.5.

### Example 82

This example includes the elements of example 69, wherein the OS visible capacity is related to the actual physical memory capacity and a capacity of the alternative storage device.

### Example 83

This example includes the elements of example 69, wherein the mapping includes relating a first OS page number to a mem page number.

### Example 84

This example includes the elements of example 83, wherein the mapping further includes relating the mem page number to at least one OS page number, the at least one OS page number including the first OS page number.

### Example 85

This example includes the elements of example 73, wherein the mapping data includes forward mapping data, the forward mapping data relating the OS page to the mem page or to the alternative storage device.

### Example 86

This example includes the elements of example 85, wherein the mapping data further includes inverse mapping data for each mem page that stores at least one OS page, the inverse mapping data to identify each OS page of the at least one OS page.

### Example 87

This example includes the elements of example 73, wherein the translation metadata includes a state indicator corresponding to a state of the OS page.

### Example 88

This example includes the elements of example 87, wherein the state indicator is selected from the group including a zero page indicator, an uncompressed indicator and a compressed indicator.

### Example 89

This example includes the elements of example 88, wherein the zero page indicator is to indicate that a corresponding OS page contains only zeros, the uncompressed indicator is to indicate that the corresponding OS page is uncompressed and the compressed indicator is to indicate that the corresponding OS page is compressed.

Example 90

This example includes the elements of example 88, wherein the translation metadata includes a mem page portion identifier if the state indicator is the compressed indicator.

### Example 91

This example includes the elements of example 90, wherein the compressed indicator and the mem page portion identifier correspond to a same bit sequence.

### Example 92

This example includes the elements of example 73, wherein the translation metadata includes a mem page portion identifier if a state of the OS page corresponds to compressed.

### Example 93

This example includes the elements of example 75, wherein the plurality of OS pages includes a zero OS page and an uncompressed OS page.

### Example 94

This example includes the elements of example 75, wherein each of the plurality of OS pages is compressed.

### Example 95

This example includes the elements of example 75, wherein the plurality of OS pages includes a zero OS page and a compressed OS page.

### Example 96

This example includes the elements of example 72, further including compressing, by the compression logic, a selected OS page or a portion of the selected OS page prior to storing the selected OS page or selected OS page portion to a target portion of a target mem page.

### Example 97

This example includes the elements of example 96, further including decompressing, by the compression logic, the selected compressed OS page or the selected OS page portion as part of a read operation.

### Example 98

This example includes the elements of example 72, wherein the OS page is compressed and the compressed OS page has a corresponding compression ratio.

### Example 99

This example includes the elements of example 98, wherein the corresponding compression ratio is related to a target compression ratio.

### Example 100

This example includes the elements of example 99, wherein the target compression ratio is two to one.

### Example 101

This example includes the elements of example 73, wherein the translation metadata includes a plurality of binary digits, a number of binary digits related to a target compression ratio.

### Example 102

This example includes the elements of example 101, wherein the number of binary digits is two, the target compression ratio is two to one and the mem page is to store up to two compressed OS pages.

### Example 103

This example includes the elements of example 101, wherein the number of binary digits is greater than two, the target compression ratio is greater than two to one and the mem page is to store more than two compressed OS pages.

### Example 104

This example includes the elements of example 69, further including determining, by the translation module, whether a selected OS page is compressible.

### Example 105

This example includes the elements of example 72, further including determining, by the compression logic, whether a selected OS page is compressible.

### Example 106

This example includes the elements of example 72, further including implementing, by the compression logic, a selected compression technique, the selected technique having one or more associated characteristics.

### Example 107

This example includes the elements of example 106, wherein the compression technique associated characteristics include one or more of compression latency, decompression latency, compressibility, capacity, power consumed during compression, power consumed during decompression, compression and decompression logic circuitry area, compression and decompression circuitry idle power, compression and decompression block data size, dictionary size, data item granularity to detect redundancy or compressibility and data granularity for compressed data items.

### Example 108

This example includes the elements of example 106, wherein the selected compression technique is selected from the group including frequent pattern compression (FPC), base-delta-immediate compression (BDI), cache packer (CPACK) compression, run length encoding (RLE), Huffman encoding, Limpel-Ziv (LZ) compression and deflate compression.

### Example 109

This example includes the elements of example 72, further including storing, by a compression dictionary, one or more repeated data value(s) and/or a code for each data item such that the code for a relatively more frequent data item is shorter than a code for a relatively less frequent data item.

### Example 110

This example includes the elements of example 73, further including, determining by the translation module, based, at least in part, on the translation data structure, at least one of a current state of a target OS page, a current storage location of the target OS page, a next state of the target OS page and/or a next storage location of the target OS page.

### Example 111

This example includes the elements of example 110, wherein the determining the next storage location includes identifying a target mem page.

### Example 112

This example includes the elements of example 111, wherein the determining the next storage location further includes identifying a target mem page portion.

### Example 113

This example includes the elements of example 111, wherein the identifying includes searching the translation data structure or an auxiliary data structure.

### Example 114

This example includes the elements of example 113, wherein the auxiliary data structure is selected from the group including inverse mapping data, a linked list and a hash table.

### Example 115

This example includes the elements of example 110, further including utilizing, by the translation module, a current OS page number as a first index into the translation data structure.

### Example 116

This example includes the elements of example 110, further including determining, by the translation module a current mem page number.

### Example 117

This example includes the elements of example 116, further including utilizing, by the translation module, the current mem page number as a second index into the translation data structure.

### Example 118

This example includes the elements of example 110, wherein the next storage location is related to the current state and the next state of the target OS page.

### Example 119

This example includes the elements of example 110, wherein the next storage location is different from the current storage location.

### Example 120

This example includes the elements of example 119, wherein the next storage location corresponds to the alternative storage device.

### Example 121

This example includes the elements of example 120, further including identifying, by the translation module, a victim OS page to be silently evicted from main memory and stored to the alternative storage device.

### Example 122

This example includes the elements of example 121, wherein the alternative storage device is a solid state drive (SSD), the SSD including an SSD controller, a translation storage portion and a general storage portion.

### Example 123

This example includes the elements of example 122, further including providing, by the translation module, the victim OS page to the SSD for storage to the translation storage portion.

### Example 124

This example includes the elements of example 122, further including managing storing, by the SSD controller, the victim OS page to the translation storage portion.

### Example 125

This example includes the elements of example 122, further including erasing, by the SSD controller, an associated SSD storage location upon at least one of a system shutdown and/or a power failure.

### Example 126

This example includes the elements of example 121, wherein the alternative storage device is a victim cache.

### Example 127

This example includes the elements of example 126, further including storing, by the translation module, a victim OS page to the victim cache prior to evicting the victim OS page to nonvolatile storage.

### Example 128

This example includes the elements of example 73, further including updating, by the translation module, one or more entries in the translation data structure.

### Example 129

This example includes the elements of example 73, further including initializing, by the translation module, the translation data structure.

### Example 130

This example includes the elements of example 129, wherein the initializing includes determining an initial state of each OS page, determining an initial storage location of each OS page, storing each nonzero OS page to a respective initial storage location and updating the mapping data and the translation metadata.

### Example 131

This example includes the elements of example 130, wherein the determining the initial state of each OS page includes determining whether a respective OS page is compressible and compressing each compressible OS page.

### Example 132

This example includes the elements of example 73, further including storing, by a translation cache, at least a portion of one or more entries included in the translation data structure.

### Example 133

This example includes the elements of example 69, further including storing, by a victim cache, a victim OS page.

### Example 134

This example includes the elements of example 133, further including identifying, by the translation module, the victim OS page.

### Example 135

This example includes the elements of example 134, wherein the identifying is based, at least in part, on one or more heuristic(s).

### Example 136

This example includes the elements of example 133, further including storing, by the translation module, the victim OS page to the victim cache temporarily.

### Example 137

This example includes the elements of example 73, wherein the translation data structure is configured as a lookup table (LUT).

### Example 138

This example includes the elements of example 73, wherein the translation data structure is multilevel.

### Example 139

This example includes the elements of example 73, wherein the translation data structure utilizes a portion of a page table.

### Example 140

This example includes the elements of example 69, wherein the mapping is performed in response to a memory access request that results in an OS memory access operation.

### Example 141

This example includes the elements of example 140, wherein the OS memory access operation is a read operation and further including determining, by the translation module, based, at least in part, on the translation data structure, a current state of a target OS page and a current storage location of the target OS page.

### Example 142

This example includes the elements of example 141, wherein the read operation further includes decompressing the target OS page.

### Example 143

This example includes the elements of example 141, further including nonvolatile storage, wherein the current location of the target OS page is the nonvolatile storage, the read operation resulting in a page fault.

### Example 144

This example includes the elements of example 143, further including identifying, by the translation module, a victim OS page to evict from memory, storing, by the translation module, the victim OS page contents to nonvolatile storage, reading, by the translation module, the target OS page contents from the nonvolatile storage and storing, by the translation module, the target OS page contents to the evicted OS page location.

### Example 145

This example includes the elements of example 144, further including determining, by the translation module, a current state and a current storage location of the victim OS page.

### Example 146

This example includes the elements of example 145, further including decompressing, by compression logic, the victim OS page contents prior to storage to nonvolatile storage if a current state of the victim OS page is compressed.

### Example 147

This example includes the elements of example 144, further including determining, by the translation module, whether the target OS page will fit into the evicted OS page storage location.

### Example 148

This example includes the elements of example 147, further including storing, by the translation module, the target OS page to the evicted OS page storage location if the target OS page will fit in the evicted OS page storage location or identifying, by the translation module, a target mem page if the target OS page will not fit in the evicted OS page storage location.

### Example 149

This example includes the elements of example 146, wherein the OS memory access operation is a write operation and further including determining, by the translation module, based, at least in part, on the translation data structure, a current state of a target OS page, a current storage location of the target OS page, a next state of the target OS page and a next storage location of the target OS page.

### Example 150

This example includes the elements of example 69, wherein the mapping is performed in response to a memory access request that results in a page fault.

### Example 151

This example includes the elements of example 150, further including identifying, by the translation module, a victim OS page to evict from memory.

### Example 152

This example includes the elements of example 151, further including determining, by the translation module, a current state and a current storage location of the victim OS page, utilizing a translation data structure.

### Example 153

According to this example, there is provided a system. The system includes a processor, a memory and a memory controller. The memory controller includes a translation module to map an operating system (OS) visible memory page (OS page) to at least a portion of an actual physical memory page (mem page) or to an alternative storage device. The OS page is interpreted by an OS as a physical memory page. An OS visible memory capacity is greater than an actual physical memory capacity.

### Example 154

This example includes the elements of example 153, wherein the translation module is further to determine a state of the OS page.

### Example 155

This example includes the elements of example 153, wherein the translation module is further to determine a storage location of the OS page.

### Example 156

This example includes the elements of example 153, wherein the memory controller further includes compression logic to compress contents of at least a portion of the OS page.

### Example 157

This example includes the elements of example 153, further including a translation data structure to store mapping data and translation metadata related to the mapping of the OS page to the at least a portion of the mem page.

### Example 158

This example includes the elements of example 154, wherein the state is selected from the group including zero, compressed and uncompressed.

### Example 159

This example includes the elements according to any one of examples 153 through 157, wherein a plurality of OS pages is mapped to one mem page.

### Example 160

This example includes the elements according to any one of examples 153 through 157, further including the alternative storage device.

### Example 161

This example includes the elements of example 160, wherein the alternative storage device is a solid state drive (SSD), the SSD including an SSD controller, a translation storage portion and a general storage portion.

### Example 162

This example includes the elements of example 160, wherein the alternative storage device is nonvolatile and is selected from the group including a solid state drive (SSD), a hard disk drive (HDD) and removable nonvolatile (NV) storage.

### Example 163

This example includes the elements of example 161, wherein a size of the translation storage portion is related to a size of the OS visible memory and to a size of the actual physical memory.

### Example 164

This example includes the elements of example 163, wherein the size of the translation storage portion corresponds to a difference between the size of the OS visible memory and the size of the actual physical memory.

### Example 165

This example includes the elements according to any one of examples 153 through 157, further including a basic input/output system (BIOS), the BIOS to store an OS visible memory capacity value that corresponds to the OS visible memory capacity.

### Example 166

This example includes the elements of example 157, wherein at least a portion of the translation data structure is stored to a translation lookaside buffer (TLB).

### Example 167

This example includes the elements of example 155, wherein the storage location is selected from the group including an identified mem page, an identified portion of the identified mem page and a translation storage portion of a solid state drive (SSD).

### Example 168

This example includes the elements according to any one of examples 153 through 157, wherein the OS visible memory capacity is related to the actual physical memory capacity by a capacity factor.

### Example 169

This example includes the elements of example 168, wherein the capacity factor is greater than one.

### Example 170

This example includes the elements of example 168, wherein the capacity factor is 1.5.

### Example 171

This example includes the elements according to any one of examples 153 through 157, wherein the OS visible capacity is related to the actual physical memory capacity and a capacity of the alternative storage device.

### Example 172.

This example includes the elements according to any one of examples 153 through 157, wherein the mapping includes relating a first OS page number to a mem page number.

### Example 173

This example includes the elements of example 172, wherein the mapping further includes relating the mem page number to at least one OS page number, the at least one OS page number including the first OS page number.

### Example 174

This example includes the elements of example 157, wherein the mapping data includes forward mapping data, the forward mapping data relating the OS page to the mem page or to the alternative storage device.

### Example 175

This example includes the elements of example 174, wherein the mapping data further includes inverse mapping data for each mem page that stores at least one OS page, the inverse mapping data to identify each OS page of the at least one OS page.

### Example 176

This example includes the elements of example 157, wherein the translation metadata includes a state indicator corresponding to a state of the OS page.

### Example 177

This example includes the elements of example 176, wherein the state indicator is selected from the group including a zero page indicator, an uncompressed indicator and a compressed indicator.

### Example 178

This example includes the elements of example 177, wherein the zero page indicator is to indicate that a corresponding OS page contains only zeros, the uncompressed indicator is to indicate that the corresponding OS page is uncompressed and the compressed indicator is to indicate that the corresponding OS page is compressed.

### Example 179

This example includes the elements of example 177, wherein the translation metadata includes a mem page portion identifier if the state indicator is the compressed indicator.

### Example 180

This example includes the elements of example 179, wherein the compressed indicator and the mem page portion identifier correspond to a same bit sequence.

### Example 181

This example includes the elements of example 157, wherein the translation metadata includes a mem page portion identifier if a state of the OS page corresponds to compressed.

### Example 182

This example includes the elements of example 159, wherein the plurality of OS pages includes a zero OS page and an uncompressed OS page.

### Example 183

This example includes the elements of example 159, wherein each of the plurality of OS pages is compressed.

### Example 184

This example includes the elements of example 159, wherein the plurality of OS pages includes a zero OS page and a compressed OS page.

### Example 185

This example includes the elements of example 156, wherein the compression logic is to compress a selected OS page or a portion of the selected OS page prior to storing the selected OS page or selected OS page portion to a target portion of a target mem page.

### Example 186

This example includes the elements of example 185, wherein the compression logic is further to decompress the selected compressed OS page or the selected OS page portion as part of a read operation.

### Example 187

This example includes the elements of example 156, wherein the OS page is compressed and the compressed OS page has a corresponding compression ratio.

### Example 188

This example includes the elements of example 187, wherein the corresponding compression ratio is related to a target compression ratio.

### Example 189

This example includes the elements of example 188, wherein the target compression ratio is two to one.

### Example 190

This example includes the elements of example 157, wherein the translation metadata includes a plurality of binary digits, a number of binary digits related to a target compression ratio.

### Example 191

This example includes the elements of example 190, wherein the number of binary digits is two, the target compression ratio is two to one and the mem page is to store up to two compressed OS pages.

### Example 192

This example includes the elements of example 190, wherein the number of binary digits is greater than two, the target compression ratio is greater than two to one and the mem page is to store more than two compressed OS pages.

### Example 193

This example includes the elements according to any one of examples 153 through 157, wherein the translation module is further to determine whether a selected OS page is compressible.

### Example 194

This example includes the elements of example 156, wherein the compression logic is further to determine whether a selected OS page is compressible.

### Example 195

This example includes the elements of example 156, wherein the compression logic is to implement a selected compression technique, the selected technique having one or more associated characteristics.

### Example 196

This example includes the elements of example 195, wherein the compression technique associated characteristics include one or more of compression latency, decompression latency, compressibility, capacity, power consumed during compression, power consumed during decompression, compression and decompression logic circuitry area, compression and decompression circuitry idle power, compression and decompression block data size, dictionary size, data item granularity to detect redundancy or compressibility and data granularity for compressed data items.

### Example 197

This example includes the elements of example 195, wherein the selected compression technique is selected from the group including frequent pattern compression (FPC), base-delta-immediate compression (BDI), cache packer (CPACK) compression, run length encoding (RLE), Huffman encoding, Limpel-Ziv (LZ) compression and deflate compression.

### Example 198

This example includes the elements of example 156, further including a compression dictionary.

### Example 199

This example includes the elements of example 198, wherein the compression dictionary is to store one or more repeated data value(s) and/or a code for each data item such that the code for a relatively more frequent data item is shorter than a code for a relatively less frequent data item.

### Example 200

This example includes the elements of example 157, wherein the translation module is to determine based, at least in part, on the translation data structure, at least one of a current state of a target OS page, a current storage location of the target OS page, a next state of the target OS page and/or a next storage location of the target OS page.

### Example 201

This example includes the elements of example 200, wherein the determining the next storage location includes identifying a target mem page.

### Example 202

This example includes the elements of example 201, wherein the determining the next storage location further includes identifying a target mem page portion.

### Example 203

This example includes the elements of example 201, wherein the identifying includes searching the translation data structure or an auxiliary data structure.

### Example 204

This example includes the elements of example 203, wherein the auxiliary data structure is selected from the group including inverse mapping data, a linked list and a hash table.

### Example 205

This example includes the elements of example 200, wherein the translation module is to utilize a current OS page number as a first index into the translation data structure.

### Example 206

This example includes the elements of example 200, wherein the translation module is to determine a current mem page number.

### Example 207

This example includes the elements of example 206, wherein the translation module is to utilize the current mem page number as a second index into the translation data structure.

### Example 208

This example includes the elements of example 200, wherein the next storage location is related to the current state and the next state of the target OS page.

### Example 209

This example includes the elements of example 200, wherein the next storage location is different from the current storage location.

### Example 210

This example includes the elements of example 209, wherein the next storage location corresponds to the alternative storage device.

### Example 211

This example includes the elements of example 210, wherein the translation module is further to identify a victim OS page to be silently evicted from main memory and stored to the alternative storage device.

### Example 212

This example includes the elements of example 211, wherein the alternative storage device is a solid state drive (SSD), the SSD including an SSD controller, a translation storage portion and a general storage portion.

### Example 213

This example includes the elements of example 212, wherein the translation module is to provide the victim OS page to the SSD for storage to the translation storage portion.

### Example 214

This example includes the elements of example 212, wherein the SSD controller is to manage storing the victim OS page to the translation storage portion.

### Example 215

This example includes the elements of example 212, wherein the SSD controller is to erase an associated SSD storage location upon at least one of a system shutdown and/or a power failure.

### Example 216

This example includes the elements of example 211, wherein the alternative storage device is a victim cache.

### Example 217

This example includes the elements of example 216, wherein the translation module is to store a victim OS page to the victim cache prior to evicting the victim OS page to nonvolatile storage.

### Example 218

This example includes the elements of example 157, wherein the translation module is further to update one or more entries in the translation data structure.

### Example 219

This example includes the elements of example 157, wherein the translation module is to initialize the translation data structure.

### Example 220

This example includes the elements of example 219, wherein the initializing includes determining an initial state of each OS page, determining an initial storage location of each OS page, storing each nonzero OS page to a respective initial storage location and updating the mapping data and the translation metadata.

### Example 221

This example includes the elements of example 220, wherein the determining the initial state of each OS page includes determining whether a respective OS page is compressible and compressing each compressible OS page.

### Example 222

This example includes the elements of example 157, further including a translation cache to store at least a portion of one or more entries included in the translation data structure.

### Example 223

This example includes the elements according to any one of examples 153 through 157, further including a victim cache to store a victim OS page.

### Example 224

This example includes the elements of example 223, wherein the translation module is to identify the victim OS page.

### Example 225

This example includes the elements of example 224, wherein the identifying is based, at least in part, on one or more heuristic(s).

### Example 226

This example includes the elements of example 223, wherein the translation module is to store the victim OS page to the victim cache temporarily.

### Example 227

This example includes the elements of example 157, wherein the translation data structure is configured as a lookup table (LUT).

### Example 228

This example includes the elements of example 157, wherein the translation data structure is multilevel.

### Example 229

This example includes the elements of example 157, wherein the translation data structure utilizes a portion of a page table.

### Example 230

This example includes the elements according to any one of examples 153 through 157, wherein the mapping is performed in response to a memory access request that results in an OS memory access operation.

### Example 231

This example includes the elements of example 230, wherein the OS memory access operation is a read operation and the translation module is to determine based, at least in part, on the translation data structure, a current state of a target OS page and a current storage location of the target OS page.

### Example 232

This example includes the elements of example 231, wherein the read operation further includes decompressing the target OS page.

### Example 233

This example includes the elements of example 231, further including nonvolatile storage, wherein the current location of the target OS page is the nonvolatile storage, the read operation resulting in a page fault.

### Example 234

This example includes the elements of example 233, wherein the translation module is to identify a victim OS page to evict from memory, to store the victim OS page contents to nonvolatile storage, to read the target OS page contents from the nonvolatile storage and to store the target OS page contents to the evicted OS page location.

### Example 235

This example includes the elements of example 234, wherein the translation module is to determine a current state and a current storage location of the victim OS page.

### Example 236

This example includes the elements of example 235, further including compression logic to decompress the victim OS page contents prior to storage to nonvolatile storage if a current state of the victim OS page is compressed.

### Example 237

This example includes the elements of example 234, wherein the translation module is to determine whether the target OS page will fit into the evicted OS page storage location.

### Example 238

This example includes the elements of example 237, wherein the translation module is to store the target OS page to the evicted OS page storage location if the target OS page will fit in the evicted OS page storage location or to identify a target mem page if the target OS page will not fit in the evicted OS page storage location.

### Example 239

This example includes the elements of example 236, wherein the OS memory access operation is a write operation and the translation module is to determine based, at least in part, on the translation data structure, a current state of a target OS page, a current storage location of the target OS page, a next state of the target OS page and a next storage location of the target OS page.

### Example 240

This example includes the elements according to any one of examples 153 through 157, wherein the mapping is performed in response to a memory access request that results in a page fault.

### Example 241

This example includes the elements of example 240, wherein the translation module is further to identify a victim OS page to evict from memory.

### Example 242

This example includes the elements of example 241, wherein the translation module is to determine a current state and a current storage location of the victim OS page, utilizing a translation data structure.

### Example 243

According to this example there is provided a computer readable storage device. The computer readable storage device has stored thereon instructions that when executed by one or more processors result in the following operations including mapping an operating system (OS) visible memory page (OS page) to at least a portion of an actual physical memory page (mem page) or to an alternative storage device. The OS page is interpreted by an OS as a physical memory page. An OS visible memory capacity is greater than an actual physical memory capacity.

### Example 244

This example includes the elements of example 243, wherein the instructions that when executed by one or more processors results in the following additional operations including determining a state of the OS page.

### Example 245

This example includes the elements of example 243, wherein the instructions that when executed by one or more processors results in the following additional operations including determining a storage location of the OS page.

### Example 246

This example includes the elements of example 243, wherein the instructions that when executed by one or more processors results in the following additional operations including compressing contents of at least a portion of the OS page.

### Example 247

This example includes the elements of example 243, wherein the instructions that when executed by one or more processors results in the following additional operations including storing mapping data and translation metadata related to the mapping of the OS page to the at least a portion of the mem page.

### Example 248

This example includes the elements of example 244, wherein the state is selected from the group including zero, compressed and uncompressed.

### Example 249

This example includes the elements according to any one of examples 243 through 247, wherein a plurality of OS pages is mapped to one mem page.

### Example 250

This example includes the elements according to any one of examples 243 through 247, wherein the instructions that when executed by one or more processors results in the following additional operations including storing an OS visible memory capacity value that corresponds to the OS visible memory capacity.

### Example 251

This example includes the elements of example 247, wherein the instructions that when executed by one or more processors results in the following additional operations including storing at least a portion of the translation data structure to a translation lookaside buffer (TLB).

### Example 252

This example includes the elements of example 245, wherein the storage location is selected from the group including an identified mem page, an identified portion of the identified mem page and a translation storage portion of a solid state drive (SSD).

### Example 253

This example includes the elements according to any one of examples 243 through 247, wherein the OS visible memory capacity is related to the actual physical memory capacity by a capacity factor.

### Example 254

This example includes the elements of example 253, wherein the capacity factor is greater than one.

### Example 255

This example includes the elements of example 253, wherein the capacity factor is 1.5.

### Example 256

This example includes the elements according to any one of examples 243 through 247, wherein the OS visible capacity is related to the actual physical memory capacity and a capacity of the alternative storage device.

### Example 257

This example includes the elements according to any one of examples 243 through 247, wherein the mapping includes relating a first OS page number to a mem page number.

### Example 258

This example includes the elements of example 257, wherein the mapping includes relating the mem page number to at least one OS page number, the at least one OS page number including the first OS page number.

### Example 259

This example includes the elements of example 247, wherein the mapping data includes forward mapping data, the forward mapping data relating the OS page to the mem page or to the alternative storage device.

### Example 260

This example includes the elements of example 259, wherein the mapping data includes inverse mapping data for each mem page that stores at least one OS page, the inverse mapping data to identify each OS page of the at least one OS page.

### Example 261

This example includes the elements of example 247, wherein the translation metadata includes a state indicator corresponding to a state of the OS page.

### Example 262

This example includes the elements of example 261, wherein the state indicator is selected from the group including a zero page indicator, an uncompressed indicator and a compressed indicator.

### Example 263

This example includes the elements of example 262, wherein the zero page indicator is to indicate that a corresponding OS page contains only zeros, the uncompressed indicator is to indicate that the corresponding OS page is uncompressed and the compressed indicator is to indicate that the corresponding OS page is compressed.

### Example 264

This example includes the elements of example 262, wherein the translation metadata includes a mem page portion identifier if the state indicator is the compressed indicator.

### Example 265

This example includes the elements of example 264, wherein the compressed indicator and the mem page portion identifier correspond to a same bit sequence.

### Example 266

This example includes the elements of example 247, wherein the translation metadata includes a mem page portion identifier if a state of the OS page corresponds to compressed.

### Example 267

This example includes the elements of example 249, wherein the plurality of OS pages includes a zero OS page and an uncompressed OS page.

### Example 268

This example includes the elements of example 249, wherein each of the plurality of OS pages is compressed.

### Example 269

This example includes the elements of example 249, wherein the plurality of OS pages includes a zero OS page and a compressed OS page.

### Example 270

This example includes the elements of example 246, wherein the instructions that when executed by one or more processors results in the following additional operations including compressing a selected OS page or a portion of the selected OS page prior to storing the selected OS page or selected OS page portion to a target portion of a target mem page.

### Example 271

This example includes the elements of example 270, wherein the instructions that when executed by one or more processors results in the following additional operations including decompressing the selected compressed OS page or the selected OS page portion as part of a read operation.

### Example 272

This example includes the elements of example 246, wherein the OS page is compressed and the compressed OS page has a corresponding compression ratio.

### Example 273

This example includes the elements of example 272, wherein the corresponding compression ratio is related to a target compression ratio.

### Example 274

This example includes the elements of example 273, wherein the target compression ratio is two to one.

### Example 275

This example includes the elements of example 247, wherein the translation metadata includes a plurality of binary digits, a number of binary digits related to a target compression ratio.

### Example 276

This example includes the elements of example 275, wherein the number of binary digits is two, the target compression ratio is two to one and the mem page is to store up to two compressed OS pages.

### Example 277

This example includes the elements of example 275, wherein the number of binary digits is greater than two, the target compression ratio is greater than two to one and the mem page is to store more than two compressed OS pages.

### Example 278

This example includes the elements according to any one of examples 243 through 247, wherein the instructions that when executed by one or more processors results in the following additional operations including determining whether a selected OS page is compressible.

### Example 279

This example includes the elements of example 246, wherein the instructions that when executed by one or more processors results in the following additional operations including determining whether a selected OS page is compressible.

### Example 280

This example includes the elements of example 246, wherein the instructions that when executed by one or more processors results in the following additional operations including implementing a selected compression technique, the selected technique having one or more associated characteristics.

### Example 281

This example includes the elements of example 280, wherein the compression technique associated characteristics include one or more of compression latency, decompression latency, compressibility, capacity, power consumed during compression, power consumed during decompression, compression and decompression logic circuitry area, compression and decompression circuitry idle power, compression and decompression block data size, dictionary size, data item granularity to detect redundancy or compressibility and data granularity for compressed data items.

### Example 282

This example includes the elements of example 280, wherein the selected compression technique is selected from the group including frequent pattern compression (FPC), base-delta-immediate compression (BDI), cache packer (CPACK) compression, run length encoding (RLE), Huffman encoding, Limpel-Ziv (LZ) compression and deflate compression.

### Example 283

This example includes the elements of example 246, wherein the instructions that when executed by one or more processors results in the following additional operations including storing one or more repeated data value(s) and/or a code for each data item such that the code for a relatively more frequent data item is shorter than a code for a relatively less frequent data item.

### Example 284

This example includes the elements of example 247, wherein the instructions that when executed by one or more processors results in the following additional operations including determining based, at least in part, on the translation data structure, at least one of a current state of a target OS page, a current storage location of the target OS page, a next state of the target OS page and/or a next storage location of the target OS page.

### Example 285

This example includes the elements of example 284, wherein the determining the next storage location includes identifying a target mem page.

### Example 286

This example includes the elements of example 285, wherein the determining the next storage location further includes identifying a target mem page portion.

### Example 287

This example includes the elements of example 285, wherein the identifying includes searching the translation data structure or an auxiliary data structure.

### Example 288

This example includes the elements of example 287, wherein the auxiliary data structure is selected from the group including inverse mapping data, a linked list and a hash table.

### Example 289

This example includes the elements of example 284, wherein the instructions that when executed by one or more processors results in the following additional operations including utilizing a current OS page number as a first index into the translation data structure.

### Example 290

This example includes the elements of example 284, wherein the instructions that when executed by one or more processors results in the following additional operations including determining a current mem page number.

### Example 291

This example includes the elements of example 290, wherein the instructions that when executed by one or more processors results in the following additional operations including utilizing the current mem page number as a second index into the translation data structure.

### Example 292

This example includes the elements of example 284, wherein the next storage location is related to the current state and the next state of the target OS page.

### Example 293

This example includes the elements of example 284, wherein the next storage location is different from the current storage location.

### Example 294

This example includes the elements of example 293, wherein the next storage location corresponds to the alternative storage device.

### Example 295

This example includes the elements of example 294, wherein the instructions that when executed by one or more processors results in the following additional operations including identifying a victim OS page to be silently evicted from main memory and stored to the alternative storage device.

### Example 296

This example includes the elements of example 295, wherein the alternative storage device is a solid state drive (SSD), the SSD including an SSD controller, a translation storage portion and a general storage portion.

### Example 297

This example includes the elements of example 296, wherein the instructions that when executed by one or more processors results in the following additional operations including providing the victim OS page to the SSD for storage to the translation storage portion.

### Example 298

This example includes the elements of example 296, wherein the instructions that when executed by one or more processors results in the following additional operations including managing storing the victim OS page to the translation storage portion.

### Example 299

This example includes the elements of example 296, wherein the instructions that when executed by one or more processors results in the following additional operations including erasing an associated SSD storage location upon at least one of a system shutdown and/or a power failure.

### Example 300

This example includes the elements of example 295, wherein the alternative storage device is a victim cache.

### Example 301

This example includes the elements of example 300, wherein the instructions that when executed by one or more processors results in the following additional operations including storing a victim OS page to the victim cache prior to evicting the victim OS page to nonvolatile storage.

### Example 302

This example includes the elements of example 247, wherein the instructions that when executed by one or more processors results in the following additional operations including updating one or more entries in the translation data structure.

### Example 303

This example includes the elements of example 247, wherein the instructions that when executed by one or more processors results in the following additional operations including initializing the translation data structure.

### Example 304

This example includes the elements of example 303, wherein the initializing includes determining an initial state of each OS page, determining an initial storage location of each OS page, storing each nonzero OS page to a respective initial storage location and updating the mapping data and the translation metadata.

### Example 305

This example includes the elements of example 304, wherein the determining the initial state of each OS page includes determining whether a respective OS page is compressible and compressing each compressible OS page.

### Example 306

This example includes the elements of example 247, wherein the instructions that when executed by one or more processors results in the following additional operations including storing at least a portion of one or more entries included in the translation data structure.

### Example 307

This example includes the elements according to any one of examples 243 through 247, wherein the instructions that when executed by one or more processors results in the following additional operations including storing a victim OS page.

### Example 308

This example includes the elements of example 307, wherein the instructions that when executed by one or more processors results in the following additional operations including identifying the victim OS page.

### Example 309

This example includes the elements of example 308, wherein the identifying is based, at least in part, on one or more heuristic(s).

### Example 310

This example includes the elements of example 307, wherein the instructions that when executed by one or more processors results in the following additional operations including storing the victim OS page to the victim cache temporarily.

### Example 311

This example includes the elements of example 247, wherein the translation data structure is configured as a lookup table (LUT).

### Example 312

This example includes the elements of example 247, wherein the translation data structure is multilevel.

### Example 313

This example includes the elements of example 247, wherein the translation data structure utilizes a portion of a page table.

### Example 314

This example includes the elements according to any one of examples 243 through 247, wherein the mapping is performed in response to a memory access request that results in an OS memory access operation.

### Example 315

This example includes the elements of example 314, wherein the OS memory access operation is a read operation and the instructions that when executed by one or more processors results in the following additional operations including determining based, at least in part, on the translation data structure, a current state of a target OS page and a current storage location of the target OS page.

### Example 316

This example includes the elements of example 315, wherein the read operation further includes decompressing the target OS page.

### Example 317

This example includes the elements of example 315, wherein the current location of the target OS page is nonvolatile storage, the read operation resulting in a page fault.

### Example 318

This example includes the elements of example 317, wherein the instructions that when executed by one or more processors results in the following additional operations including identifying a victim OS page to evict from memory, storing the victim OS page contents to nonvolatile storage, reading the target OS page contents from the nonvolatile storage and storing the target OS page contents to the evicted OS page location.

### Example 319

This example includes the elements of example 318, wherein the instructions that when executed by one or more processors results in the following additional operations including determining a current state and a current storage location of the victim OS page.

### Example 320

This example includes the elements of example 319, wherein the instructions that when executed by one or more processors results in the following additional operations including decompressing the victim OS page contents prior to storage to nonvolatile storage if a current state of the victim OS page is compressed.

### Example 321

This example includes the elements of example 318, wherein the instructions that when executed by one or more processors results in the following additional operations including determining whether the target OS page will fit into the evicted OS page storage location.

### Example 322

This example includes the elements of example 321, wherein the instructions that when executed by one or more processors results in the following additional operations including storing the target OS page to the evicted OS page storage location if the target OS page will fit in the evicted OS page storage location or identifying a target mem page if the target OS page will not fit in the evicted OS page storage location.

### Example 323

This example includes the elements of example 320, wherein the OS memory access operation is a write operation and wherein the instructions that when executed by one or more processors results in the following additional operations including determining based, at least in part, on the translation data structure, a current state of a target OS page, a current storage location of the target OS page, a next state of the target OS page and a next storage location of the target OS page.

### Example 324

This example includes the elements according to any one of examples 243 through 247, wherein the mapping is performed in response to a memory access request that results in a page fault.

### Example 325

This example includes the elements of example 324, wherein the instructions that when executed by one or more processors results in the following additional operations including identifying a victim OS page to evict from memory.

### Example 326

This example includes the elements of example 325, wherein the instructions that when executed by one or more processors results in the following additional operations including determining a current state and a current storage location of the victim OS page, utilizing a translation data structure.

### Example 327

According to this example there is provided a device. The device includes means for mapping, by a translation module, an operating system (OS) visible memory page (OS page) to at least a portion of an actual physical memory page (mem page) or to an alternative storage device, the OS page is interpreted by an OS as a physical memory page, an OS visible memory capacity is greater than an actual physical memory capacity.

### Example 328

This example includes the elements of example 327, further including means for determining, by the translation module, a state of the OS page.

### Example 329

This example includes the elements of example 327, further including means for determining, by the translation module, a storage location of the OS page.

### Example 330

This example includes the elements of example 327, further including means for compressing, by compression logic, contents of at least a portion of the OS page.

### Example 331

This example includes the elements of example 327, further including means for storing, by a translation data structure, mapping data and translation metadata related to the mapping of the OS page to the at least a portion of the mem page.

### Example 332

This example includes the elements of example 328, wherein the state is selected from the group including zero, compressed and uncompressed.

### Example 333

This example includes the elements according to any one of examples 327 through 331, wherein a plurality of OS pages is mapped to one mem page.

### Example 334

This example includes the elements according to any one of examples 327 through 331, further including means for storing, by a basic input/output system (BIOS), an OS visible memory capacity value that corresponds to the OS visible memory capacity.

### Example 335

This example includes the elements of example 331, further including means for storing, by the translation module, at least a portion of the translation data structure to a translation lookaside buffer (TLB).

### Example 336

This example includes the elements of example 329, wherein the storage location is selected from the group including an identified mem page, an identified portion of the identified mem page and a translation storage portion of a solid state drive (SSD).

### Example 337

This example includes the elements according to any one of examples 327 through 331, wherein the OS visible memory capacity is related to the actual physical memory capacity by a capacity factor.

### Example 338

This example includes the elements of example 337, wherein the capacity factor is greater than one.

### Example 339

This example includes the elements of example 337, wherein the capacity factor is 1.5.

### Example 340

This example includes the elements according to any one of examples 327 through 331, wherein the OS visible capacity is related to the actual physical memory capacity and a capacity of the alternative storage device.

### Example 341

This example includes the elements according to any one of examples 327 through 331, wherein the mapping includes relating a first OS page number to a mem page number.

### Example 342

This example includes the elements of example 341, wherein the mapping further includes relating the mem page number to at least one OS page number, the at least one OS page number including the first OS page number.

### Example 343

This example includes the elements of example 331, wherein the mapping data includes forward mapping data, the forward mapping data relating the OS page to the mem page or to the alternative storage device.

### Example 344

This example includes the elements of example 343, wherein the mapping data further includes inverse mapping data for each mem page that stores at least one OS page, the inverse mapping data to identify each OS page of the at least one OS page.

### Example 345

This example includes the elements of example 331, wherein the translation metadata includes a state indicator corresponding to a state of the OS page.

### Example 346

This example includes the elements of example 345, wherein the state indicator is selected from the group including a zero page indicator, an uncompressed indicator and a compressed indicator.

### Example 347

This example includes the elements of example 346, wherein the zero page indicator is to indicate that a corresponding OS page contains only zeros, the uncompressed indicator is to indicate that the corresponding OS page is uncompressed and the compressed indicator is to indicate that the corresponding OS page is compressed.

### Example 348

This example includes the elements of example 346, wherein the translation metadata includes a mem page portion identifier if the state indicator is the compressed indicator.

### Example 349

This example includes the elements of example 348, wherein the compressed indicator and the mem page portion identifier correspond to a same bit sequence.

### Example 350

This example includes the elements of example 331, wherein the translation metadata includes a mem page portion identifier if a state of the OS page corresponds to compressed.

### Example 351

This example includes the elements of example 333, wherein the plurality of OS pages includes a zero OS page and an uncompressed OS page.

### Example 352

This example includes the elements of example 333, wherein each of the plurality of OS pages is compressed.

### Example 353

This example includes the elements of example 333, wherein the plurality of OS pages includes a zero OS page and a compressed OS page.

### Example 354

This example includes the elements of example 330, further including means for compressing, by the compression logic, a selected OS page or a portion of the selected OS page prior to storing the selected OS page or selected OS page portion to a target portion of a target mem page.

### Example 355

This example includes the elements of example 354, further including means for decompressing, by the compression logic, the selected compressed OS page or the selected OS page portion as part of a read operation.

### Example 356

This example includes the elements of example 330, wherein the OS page is compressed and the compressed OS page has a corresponding compression ratio.

### Example 357

This example includes the elements of example 356, wherein the corresponding compression ratio is related to a target compression ratio.

### Example 358

This example includes the elements of example 357, wherein the target compression ratio is two to one.

### Example 359

This example includes the elements of example 331, wherein the translation metadata includes a plurality of binary digits, a number of binary digits related to a target compression ratio.

### Example 360

This example includes the elements of example 359, wherein the number of binary digits is two, the target compression ratio is two to one and the mem page is to store up to two compressed OS pages.

### Example 361

This example includes the elements of example 359, wherein the number of binary digits is greater than two, the target compression ratio is greater than two to one and the mem page is to store more than two compressed OS pages.

### Example 362

This example includes the elements according to any one of examples 327 through 331, further including means for determining, by the translation module, whether a selected OS page is compressible.

### Example 363

This example includes the elements of example 330, further including means for determining, by the compression logic, whether a selected OS page is compressible.

### Example 364

This example includes the elements of example 330, further including means for implementing, by the compression logic, a selected compression technique, the selected technique having one or more associated characteristics.

### Example 365

This example includes the elements of example 364, wherein the compression technique associated characteristics include one or more of compression latency, decompression latency, compressibility, capacity, power consumed during compression, power consumed during decompression, compression and decompression logic circuitry area, compression and decompression circuitry idle power, compression and decompression block data size, dictionary size, data item granularity to detect redundancy or compressibility and data granularity for compressed data items.

### Example 366

This example includes the elements of example 364, wherein the selected compression technique is selected from the group including frequent pattern compression (FPC), base-delta-immediate compression (BDI), cache packer (CPACK) compression, run length encoding (RLE), Huffman encoding, Limpel-Ziv (LZ) compression and deflate compression.

### Example 367

This example includes the elements of example 330, further including means for storing, by a compression dictionary, one or more repeated data value(s) and/or a code for each data item such that the code for a relatively more frequent data item is shorter than a code for a relatively less frequent data item.

### Example 368

This example includes the elements of example 331, further including means for determining by the translation module, based, at least in part, on the translation data structure, at least one of a current state of a target OS page, a current storage location of the target OS page, a next state of the target OS page and/or a next storage location of the target OS page.

### Example 369

This example includes the elements of example 368, wherein the determining the next storage location includes identifying a target mem page.

### Example 370

This example includes the elements of example 369, wherein the determining the next storage location further includes identifying a target mem page portion.

### Example 371

This example includes the elements of example 369, wherein the identifying includes searching the translation data structure or an auxiliary data structure.

### Example 372

This example includes the elements of example 371, wherein the auxiliary data structure is selected from the group including inverse mapping data, a linked list and a hash table.

### Example 373

This example includes the elements of example 368, further including means for utilizing, by the translation module, a current OS page number as a first index into the translation data structure.

### Example 374

This example includes the elements of example 368, further including means for determining, by the translation module a current mem page number.

### Example 375

This example includes the elements of example 374, further including means for utilizing, by the translation module, the current mem page number as a second index into the translation data structure.

### Example 376

This example includes the elements of example 368, wherein the next storage location is related to the current state and the next state of the target OS page.

### Example 377

This example includes the elements of example 368, wherein the next storage location is different from the current storage location.

### Example 378

This example includes the elements of example 377, wherein the next storage location corresponds to the alternative storage device.

### Example 379

This example includes the elements of example 378, further including means for identifying, by the translation module, a victim OS page to be silently evicted from main memory and stored to the alternative storage device.

### Example 380

This example includes the elements of example 379, wherein the alternative storage device is a solid state drive (SSD), the SSD including an SSD controller, a translation storage portion and a general storage portion.

### Example 381

This example includes the elements of example 380, further including means for providing, by the translation module, the victim OS page to the SSD for storage to the translation storage portion.

### Example 382

This example includes the elements of example 380, further including means for managing storing, by the SSD controller, the victim OS page to the translation storage portion.

### Example 383

This example includes the elements of example 380, further including means for erasing, by the SSD controller, an associated SSD storage location upon at least one of a system shutdown and/or a power failure.

### Example 384

This example includes the elements of example 379, wherein the alternative storage device is a victim cache.

### Example 385

This example includes the elements of example 384, further including means for storing, by the translation module, a victim OS page to the victim cache prior to evicting the victim OS page to nonvolatile storage.

### Example 386

This example includes the elements of example 331, further including means for updating, by the translation module, one or more entries in the translation data structure.

### Example 387

This example includes the elements of example 331, further including means for initializing, by the translation module, the translation data structure.

### Example 388

This example includes the elements of example 387, wherein the initializing includes determining an initial state of each OS page, determining an initial storage location of each OS page, storing each nonzero OS page to a respective initial storage location and updating the mapping data and the translation metadata.

### Example 389

This example includes the elements of example 388, wherein the determining the initial state of each OS page includes determining whether a respective OS page is compressible and compressing each compressible OS page.

### Example 390

This example includes the elements of example 331, further including means for storing, by a translation cache, at least a portion of one or more entries included in the translation data structure.

### Example 391

This example includes the elements according to any one of examples 327 through 331, further including means for storing, by a victim cache, a victim OS page.

### Example 392

This example includes the elements of example 391, further including means for identifying, by the translation module, the victim OS page.

### Example 393

This example includes the elements of example 392, wherein the identifying is based, at least in part, on one or more heuristic(s).

### Example 394

This example includes the elements of example 391, further including means for storing, by the translation module, the victim OS page to the victim cache temporarily.

### Example 395

This example includes the elements of example 331, wherein the translation data structure is configured as a lookup table (LUT).

### Example 396

This example includes the elements of example 331, wherein the translation data structure is multilevel.

### Example 397

This example includes the elements of example 331, wherein the translation data structure utilizes a portion of a page table.

### Example 398

This example includes the elements according to any one of examples 327 through 331, wherein the mapping is performed in response to a memory access request that results in an OS memory access operation.

### Example 399

This example includes the elements of example 398, wherein the OS memory access operation is a read operation and further including means for determining, by the translation module, based, at least in part, on the translation data structure, a current state of a target OS page and a current storage location of the target OS page.

### Example 400

This example includes the elements of example 399, wherein the read operation further includes decompressing the target OS page.

### Example 401

This example includes the elements of example 399, further including means for nonvolatile storage, wherein the current location of the target OS page is the nonvolatile storage, the read operation resulting in a page fault.

### Example 402

This example includes the elements of example 401, further including means for identifying, by the translation module, a victim OS page to evict from memory, means for storing, by the translation module, the victim OS page contents to nonvolatile storage, means for reading, by the translation module, the target OS page contents from the nonvolatile storage and means for storing, by the translation module, the target OS page contents to the evicted OS page location.

### Example 403

This example includes the elements of example 402, further including means for determining, by the translation module, a current state and a current storage location of the victim OS page.

### Example 404

This example includes the elements of example 403, further including means for decompressing, by compression logic, the victim OS page contents prior to storage to nonvolatile storage if a current state of the victim OS page is compressed.

### Example 405

This example includes the elements of example 402, further including means for determining, by the translation module, whether the target OS page will fit into the evicted OS page storage location.

### Example 406

This example includes the elements of example 405, further including means for storing, by the translation module, the target OS page to the evicted OS page storage location if the target OS page will fit in the evicted OS page storage location or means for identifying, by the translation module, a target mem page if the target OS page will not fit in the evicted OS page storage location.

### Example 407

This example includes the elements of example 404, wherein the OS memory access operation is a write operation and further including means for determining, by the translation module, based, at least in part, on the translation data structure, a current state of a target OS page, a current storage location of the target OS page, a next state of the target OS page and a next storage location of the target OS page.

### Example 408

This example includes the elements according to any one of examples 327 through 331, wherein the mapping is performed in response to a memory access request that results in a page fault.

### Example 409

This example includes the elements of example 408, further including means for identifying, by the translation module, a victim OS page to evict from memory.

### Example 410

This example includes the elements of example 409, further including means for determining, by the translation module, a current state and a current storage location of the victim OS page, utilizing a translation data structure.

### Example 411

This example includes the elements of example 5, wherein the translation metadata includes one field.

### Example 412

This example includes the elements of example 5, wherein the translation metadata includes more than one field.

### Example 413

This example includes the elements of example 73, wherein the translation metadata includes one field.

### Example 414

This example includes the elements of example 73, wherein the translation metadata includes more than one field.

### Example 415

This example includes the elements of example 157, wherein the translation metadata includes one field.

### Example 416

This example includes the elements of example 157, wherein the translation metadata includes more than one field.

### Example 417

This example includes the elements of example 247, wherein the translation metadata includes one field.

### Example 418

This example includes the elements of example 247, wherein the translation metadata includes more than one field.

### Example 419

This example includes the elements of example 331, wherein the translation metadata includes one field.

### Example 420

This example includes the elements of example 331, wherein the translation metadata includes more than one field.

### Example 421

According to this example, there is provided a system. The system includes at least one device arranged to perform the method of any one of examples 69 to 152 and 413 and 414.

### Example 422

According to this example, there is provided a device. The device includes means to perform the method of any one of examples 69 to 152 and 413 and 414.

### Example 423

According to this example, there is provided a computer readable storage device. The computer readable storage device has stored thereon instructions that when executed by one or more processors result in the following operations including: the method according to any one of examples 69 to 152 and 413 and 414.

### Example 424

This example includes the elements according to any one of examples 153 through 157, further including at least one of a network interface, a display, a battery, the at least one of a network interface, a display, a battery communicatively coupled to the processor.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An apparatus comprising:
a translation module to map an operating system (OS) visible memory page (OS page) to at least a portion of an actual physical memory page (mem page) or to an alternative storage device, the OS page is interpreted by an OS as a physical memory page, an OS visible memory capacity is greater than an actual physical memory capacity.

2. The apparatus of claim 1, wherein the translation module is further to determine a state of the OS page.

3. The apparatus of claim 1, wherein the translation module is further to determine a storage location of the OS page.

4. The apparatus of claim 1, further comprising compression logic to compress contents of at least a portion of the OS page.

5. The apparatus of claim 1, further comprising a translation data structure to store mapping data and translation metadata related to the mapping of the OS page to the at least a portion of the mem page.

6. The apparatus of claim 2, wherein the state is selected from the group comprising zero, compressed and uncompressed.

7. The apparatus of claim 1, wherein a plurality of OS pages is mapped to one mem page.

8. A method comprising:
mapping, by a translation module, an operating system (OS) visible memory page (OS page) to at least a portion of an actual physical memory page (mem page) or to an alternative storage device, the OS page is interpreted by an OS as a physical memory page, an OS visible memory capacity is greater than an actual physical memory capacity.

9. The method of claim 8, further comprising determining, by the translation module, a state of the OS page.

10. The method of claim 8, further comprising determining, by the translation module, a storage location of the OS page.

11. The method of claim 8, further comprising compressing, by compression logic, contents of at least a portion of the OS page.

12. The method of claim 8, further comprising storing, by a translation data structure, mapping data and translation metadata related to the mapping of the OS page to the at least a portion of the mem page.

13. The method of claim 9, wherein the state is selected from the group comprising zero, compressed and uncompressed.

14. The method of claim 8, wherein a plurality of OS pages is mapped to one mem page.

15. A system comprising:
a processor;
a memory; and
a memory controller comprising a translation module to map an operating system (OS) visible memory page (OS page) to at least a portion of an actual physical memory page (mem page) or to an alternative storage device, the OS page is interpreted by an OS as a physical memory page, an OS visible memory capacity is greater than an actual physical memory capacity.

16. The system of claim 15, wherein the translation module is further to determine a state of the OS page.

17. The system of claim 15, wherein the translation module is further to determine a storage location of the OS page.

18. The system of claim 15, wherein the memory controller further comprises compression logic to compress contents of at least a portion of the OS page.

19. The system of claim 15, further comprising a translation data structure to store mapping data and translation metadata related to the mapping of the OS page to the at least a portion of the mem page.

20. The system of claim 16, wherein the state is selected from the group comprising zero, compressed and uncompressed.

21. The system of claim 15, wherein a plurality of OS pages is mapped to one mem page.

22. The system of claim 15, further comprising the alternative storage device.

23. The system of claim 22, wherein the alternative storage device is a solid state drive (SSD), the SSD comprising an SSD controller, a translation storage portion and a general storage portion.

24. The system of claim 15, further comprising at least one of a network interface, a display, a battery, the at least one of a network interface, a display, a battery communicatively coupled to the processor.
